(19) United States
(12) Patent Application Publication
(10) Pub. No.: US 2026/0087875 A1
(43) Pub. Date: Mar. 26, 2026

(54) SYSTEMS AND METHODS FOR DETECTING AND ACCOUNTING FOR FEATURES OF WAGERING GAME

(71) Applicant: Aristocrat Technologies, Inc., Las Vegas, NV (US)

(72) Inventors: Robert Butler, Austin, TX (US); Eric Santana, Pflugerville, TX (US); Jeannie Chiem, Georgetown, TX (US)

(21) Appl. No.: 18/894,880

(22) Filed: Sep. 24, 2024

(51) Int. Cl. G07F 17/32; G06T 7/10; G06T 7/60; G06T 7/90; G06V 10/26; G06V 10/56; G06V 10/82

(52) U.S. Cl. CPC G07F 17/322; G06T 7/10; G06T 7/60; G06T 7/90; G06V 10/26; G06V 10/56; G06V 10/82; G06T 2207/20081; G06T 2207/20084; G06T 2207/20112; G06T 2207/30242; G06T 2210/12

(57) ABSTRACT

A system for detecting sets of wagering chips for wagering game applications may include at least one storage device and/or circuitry. The storage device may be configured to store data that represents an image of a set of wagering chips. The circuitry may be configured to detect, via an object detection model, a bounding box of at least one of the wagering chips based on the image and to identify an attribute of the at least one of the wagering chips based at least in part on the image. The circuitry may also be configured to estimate a total value of the set of wagering chips based on the attribute of the at least one of the wagering chips. The circuitry may be further configured to account for the total value of the set of wagering chips in a wagering game application. Various other systems and methods are also disclosed.

### BACKGROUND

Real-world table games (e.g., poker, blackjack, roulette, craps, etc.) often involve players who make bets with wagering chips of various values. Unfortunately, detecting and/or verifying the total value of such bets may prove challenging and/or unworkable. In addition, roulette games typically involve a spinning wheel that includes various slots fitted to accept and/or catch a moving ball. Unfortunately, detecting and/or identifying which slot ultimately catches the ball and/or which number corresponds to such a slot may prove challenging and/or unworkable. The instant disclosure, therefore, identifies and addresses a need for improved systems and methods for detecting and/or accounting for features of wagering games.

### SUMMARY

As will be described in greater detail below, the instant disclosure generally relates to systems and methods for detecting and/or accounting for features of wagering games. In some examples, a system for accomplishing such a task may include and/or implement at least one storage device and/or circuitry. In one example, the storage device may be configured to store data that represents at least one image of a set of wagering chips. In this example, the circuitry may be configured to detect, via an object detection model of an artificial intelligence (AI) model, a bounding box of at least one of the wagering chips included in the set based at least in part on the image represented in the data and to identify an attribute of the at least one of the wagering chips based at least in part on the image represented in the data. In this example, the circuitry may also be configured to estimate a total value of the set of wagering chips based at least in part on the attribute of the at least one of the wagering chips. The circuitry may be further configured to account for the total value of the set of wagering chips in a wagering game application.

In some examples, the AI model may be trained by training data that includes images of an individual wagering chip captured at different angles, images of an individual wagering chip captured at different rotations, images of stacks of wagering chips with different combinations of colors, and/or images of stacks of wagering chips with different orders of color combinations. In certain implementations, the set of wagering chips may be configured in a stack.

In some examples, the circuitry may be further configured to detect, via the object detection model, an additional bounding box of the stack based at least in part on the image represented in the data. In one example, the circuitry may be further configured to identify an attribute of the stack based at least in part on the additional bounding box. In this example, the circuitry may be further configured to estimate the total value of the stack based at least in part on the attribute of the stack and the attribute of the at least one of the wagering chips.

In some examples, the circuitry may be further configured to measure at least one dimension of the stack based at least in part on the image represented in the data. In one example, the circuitry may be further configured to estimate the total value of the stack based at least in part on the dimension of the stack.

In some examples, the circuitry may be further configured to apply the bounding box to a top wagering chip included in the stack and/or apply an additional bounding box to the stack. In one example, the circuitry may be further configured to measure the dimension of the stack by estimating a difference between a bottom of the top wagering chip and a bottom of the stack based at least in part on the bounding box and the additional bounding box.

In some examples, the circuitry may be further configured to estimate a height measurement of a wagering chip included in the stack as captured in the image. In one example, the circuitry is further configured to do so by identifying a set of coordinates corresponding to the wagering chip as captured in the image, normalizing a diameter measurement of the wagering chip based at least in part on the set of coordinates, multiplying the diameter measurement by a known height of the wagering chip, and then dividing a product of the diameter measurement and the known height by a known diameter of the wagering chip. In this example, the circuitry is further configured to estimate a height measurement of the stack based at least in part on the height measurement of the wagering chip.

In some examples, the circuitry may be further configured to adjust the height measurement of the wagering chip to account for a projection of the height measurement of the wagering chip on an image plane of the image. In one example, the circuitry is further configured to identifying an additional set of coordinates corresponding to the wagering chip as captured in the image, normalizing an angle measurement of the wagering chip based at least in part on the additional set of coordinates, and then multiplying the height measurement of the wagering chip by a sine function involving the angle measurement. In certain implementations, the sine function may include a sine function of a difference between a half of pi and an inverse sine function of the angle measurement divided by the diameter measurement.

In some examples, the circuitry may be further configured to count a total number of wagering chips included in the set based at least in part on the adjusted height measurement. In one example, the circuitry may be further configured to identify, via an instance segmentation model of the AI model, at least one wagering chip included in the set as being of a first color and/or to identify, via the instance segmentation model, at least one additional wagering chip included in the set as being of a second color. In this example, the circuitry may be further configured to estimate the total value of the set by applying a first value to the wagering chip due at least in part to the wagering chip being of the first color and applying a second value to the additional wagering chip due at least in part to the additional wagering chip being of the second color.

In some examples, the circuitry may be further configured to associate, via the object detection model, each of the wagering chips included in the set with at least one stack captured in the image. Additionally or alternatively, the circuitry may be further configured to estimate the total value of the at least one stack based at least in part on the first value applied to the wagering chip and the second value applied to the additional wagering chip.

In some examples, the circuitry may be further configured to identify the wagering chip as being of the first color by filtering the set for the first color and/or to identify the additional wagering chip as being of the second color by filtering the set for the second color. In one example, the circuitry may be further configured to identify the wagering chip as being of the first color based at least in part on a combination of a hue of the wagering chip, a light intensity of the wagering chip, and a color saturation of the wagering chip. Additionally or alternatively, the circuitry may be further configured to identify the additional wagering chip as being of the second color based at least in part on a combination of a hue of the additional wagering chip, a light intensity of the additional wagering chip, and a color saturation of the additional wagering chip.

In some examples, the circuitry may be further configured to identify the set of wagering chips as being in an unstacked configuration based at least in part on the image and/or to segment the set of wagering chips into individual graphical representations. In one example, the circuitry may be further configured to create a virtual stack of the wagering chips by pasting the individual graphical representations atop of one another in a stacked configuration. Additionally or alternatively, the circuitry may be further configured to incorporate the virtual stack in the wagering game application.

In some examples, the circuitry may be further configured to count a total number of wagering chips included in the set based at least in part on the virtual stack. In one example, the circuitry may be further configured to standardize one or more dimensions of the wagering chips included in the virtual stack against a virtual canvas. Additionally or alternatively, the system may also include and/or implement a camera device configured to capture the image of a set of wagering chips.

Similarly, a corresponding computer-implemented method may include and/or involve detecting, by circuitry implementing an object detection model of an artificial intelligence (AI) model, a bounding box of at least one wagering chip based at least in part on data that represents at least one image of a set of wagering chips. In one example, the computer-implemented method may also include and/or involve identifying, by the circuitry, an attribute of the at least one wagering chip based at least in part on the bounding box. The computer-implemented method may also include and/or involve estimating, by the circuitry, a total value of the set of wagering chips based at least in part on the attribute of the at least one wagering chip. The computer-implemented method may further include and/or involve accounting for the total value of the set of wagering chips in a wagering game application.

In some examples, a non-transitory computer-readable medium that facilitates and/or implements the above-identified method may include one or more computer-executable instructions. When executed by at least one processor of a computing device, the computer-executable instructions may cause the processor to detect, via an object detection model of an artificial intelligence (AI) model, a bounding box of at least one wagering chip based at least in part on data that represents at least one image of a set of wagering chips and to identify an attribute of the at least one wagering chip based at least in part on the bounding box. In one example, when executed by the hardware processor of the computing device, the computer-executable instructions may also cause the hardware processor to estimate a total value of the set of wagering chips based at least in part on the attribute of the at least one wagering chip. In this example, when executed by the hardware processor of the computing device, the computer-executable instructions may also cause the processor to account for the total value of the set of wagering chips in a wagering game application.

Features from any of the above-mentioned embodiments may be used in combination with one another in accordance with the general principles described herein. These and other embodiments, features, and advantages will be more fully understood upon reading the following detailed description. While the exemplary embodiments described herein are susceptible to various modifications and alternative forms, specific embodiments will be described in detail herein. However, the exemplary embodiments described herein are not intended to be limited to the particular forms disclosed. Rather, the instant disclosure covers all modifications, equivalents, and alternatives falling within this disclosure.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an exemplary diagram showing several electronic gaming machines (EGMs) networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is an illustration of an exemplary system for detecting and/or accounting for features of wagering games according to one or more embodiments of this disclosure.

FIG. 5 is an illustration of an exemplary implementation in which features of wagering games are detected and/or accounted for according to one or more embodiments of this disclosure.

FIG. 6 is an illustration of an exemplary projection of a wagering chip's height measurement on an image plane according to one or more implementations of this disclosure.

FIG. 7 is an illustration of exemplary color filtering of wagering chips arranged across a tabletop according to one or more implementations of this disclosure.

FIG. 8 is an illustration of an exemplary virtual stack reconstructed and/or created for presentation according to one or more implementations of this disclosure.

FIG. 9 is an illustration of an exemplary implementation in which features of wagering games are detected and/or accounted for according to one or more embodiments of this disclosure.

FIG. 10 is an illustration of an exemplary implementation in which features of wagering games are detected and/or accounted for according to one or more embodiments of this disclosure.

FIG. 11 is an illustration of an exemplary implementation in which features of wagering games are detected and/or accounted for according to one or more embodiments of this disclosure.

FIG. 12 is an illustration of an exemplary implementation in which features of wagering games are detected and/or accounted for according to one or more embodiments of this disclosure.

FIG. 13 is a flow diagram of an exemplary computer-implemented method for detecting and/or accounting for features of wagering games according to one or more embodiments of this disclosure.

FIG. 14 is a flow diagram of an exemplary computer-implemented method for detecting and/or accounting for features of wagering games according to one or more embodiments of this disclosure.

FIG. 15 is a flow diagram of an exemplary computer-implemented method for detecting and/or accounting for features of wagering games according to one or more embodiments of this disclosure.

FIG. 16 is an illustration of an exemplary system for detecting and/or accounting for features of wagering games according to one or more embodiments of this disclosure.

FIG. 17 is an illustration of an exemplary implementation in which features of wagering games are detected and/or accounted for according to one or more embodiments of this disclosure.

FIG. 18 is an illustration of an exemplary implementation in which features of wagering games are detected and/or accounted for according to one or more embodiments of this disclosure.

FIG. 19 is an illustration of an exemplary implementation in which features of wagering games are detected and/or accounted for according to one or more embodiments of this disclosure.

FIG. 20 is an illustration of an exemplary implementation in which features of wagering games are detected and/or accounted for according to one or more embodiments of this disclosure.

FIG. 21 is a flow diagram of an exemplary computer-implemented method for detecting and/or accounting for features of wagering games according to one or more embodiments of this disclosure.

Throughout the drawings, identical reference characters and descriptions may indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Embodiments of the instant disclosure are generally directed to detecting and accounting for features of wagering games. Some of the systems disclosed herein are configured and/or designed to detect and/or verify sets of wagering chips for wagering game applications. As a specific example, a real-world table game (e.g., poker, blackjack, roulette, craps, etc.) may be monitored by security personnel via cameras. In one example, a player involved in the real-world table game may make a bet with wagering chips. In this example, the security personnel may want to verify and/or validate the bet made by the player. For example, the security personnel may want to confirm that the player's announcement of the bet matches the total value of the wagering chips corresponding to the bet.

In some examples, a computer-vision system may be implemented in connection with the real-world table game to facilitate verifying and/or validating the bet. For example, the computer-vision system may include and/or represent a camera positioned to capture one or more images of the player's bet. In this example, the computer-vision system may also include and/or represent circuitry that implements and/or applies an AI model (e.g., machine learning, neural networks, etc.) capable of detecting the value of the player's bet based at least in part on the images captured by the camera.

In some examples, the AI model may identify and/or determine certain attributes of the wagering chips corresponding to the player's bet based at least in part on the images. For example, the AI model may identify and/or determine the height of each wagering chip included in a chip stack, the color of each wagering chip included in a chip stack, and/or the height of the chip stack. In one example, the AI model may estimate and/or calculate the total value of the wagering chips corresponding to the player's bet based at least in part on such attributes.

In some examples, the computer-vision system may account for the total value of the wagering chips as estimated and/or calculated by the AI model. For example, the computer-vision system may present and/or display the total value of the wagering chips corresponding to the player's bet for viewing by the security personnel. On the one hand, the computer-vision system and/or the security personnel may verify, confirm, and/or validate the player's bet by checking whether the total value of the wagering chips as estimated and/or calculated by the AI model matches the player's announcement of the bet. On the other hand, the computer-vision system and/or the security personnel may disqualify, discredit, and/or invalidate the player's bet by checking whether the total value of the wagering chips as estimated and/or calculated by the AI model matches the player's announcement of the bet. In this case, the computer-vision system and/or the security personnel may take and/or perform one or more remedial actions (e.g., notify the table game's dealer, warn or penalize the player, suspend or cancel the game, etc.) to address the disqualified, discredit, and/or invalidated player's bet.

Various other types of wagering game applications may incorporate and/or implement such computer-vision technology. For example, a television or streaming program may incorporate and/or implement a computer-vision system in connection with a live poker game. In this example, the computer-vision system may detect the values of chip stacks corresponding to players' bets in connection with a live poker game and then enable and/or cause the television or streaming program to display those values for viewers.

Some of the other systems disclosed herein are configured and/or designed to detect and/or identify winning roulette numbers during roulette wheel spins. As a specific example, a roulette game may be monitored by security personnel, game participants, and/or game observers via cameras. In one example, the roulette dealer may spin the roulette wheel and/or launch the ball along the corresponding ball track. Unfortunately, some people may have difficulty tracking a roulette ball after it lands in a slot on a roulette wheel while the roulette wheel continues spinning. In other words, such people may be unable to follow the roulette ball and/or the winning slot as it rotates around the spinning wheel. As a result, such people may misidentify the slot that caught the roulette ball until the roulette wheel slows down and/or stops.

In this example, a computer-vision system may be implemented in connection with the roulette game to facilitate detecting and/or identifying the winning number while the roulette wheel is spinning. For example, the computer-vision system may include and/or represent a camera positioned to record and/or capture video of the roulette wheel spin. In this example, the computer-vision system may also include and/or represent circuitry that implements and/or applies an AI model (e.g., machine learning, neural networks, etc.) capable of detecting and/or identifying the winning number during the roulette wheel spin based at least in part on the video.

In some examples, the AI model may include and/or represent an object detection model that facilitates and/or supports detecting and/or identifying the slot into which the roulette ball lands as part of the roulette wheel spin based at least in part on attributes of the video and/or one or more of its constituent still images. In one example, the object detection model may perform and/or complete this detection while the roulette wheel is spinning. In this example, the computer-vision system may rotate an image extracted from the video to align with a reference position associated with the roulette wheel. For example, the computer-vision system may apply one or more trigonometric functions to calculate the angle by which the image is rotated toward the reference position to align the slot that caught the roulette ball with the reference position. Such trigonometric functions may be based on and/or involve the center of the roulette wheel, the initial position of the slot that caught the roulette ball, and/or the reference position.

In some examples, the computer-vision system may crop the rotated image around the number corresponding to the slot that caught the roulette ball and/or is aligned with the reference position. In one example, the AI model may include and/or represent a classification model that facilitates and/or supports detecting and/or identifying the number corresponding to the slot into which the roulette ball lands based at least in part on attributes of the cropped image. In this example, the classification model may generate and/or provide a score that represents the probability that the winning number has been identified correctly and/or successfully. Additionally or alternatively, the computer-vision system may present and/or display the winning number in a wagering game application. For example, the computer-vision system may present and/or display the winning number for viewing by the security personnel, the game participants, and/or the game observers.

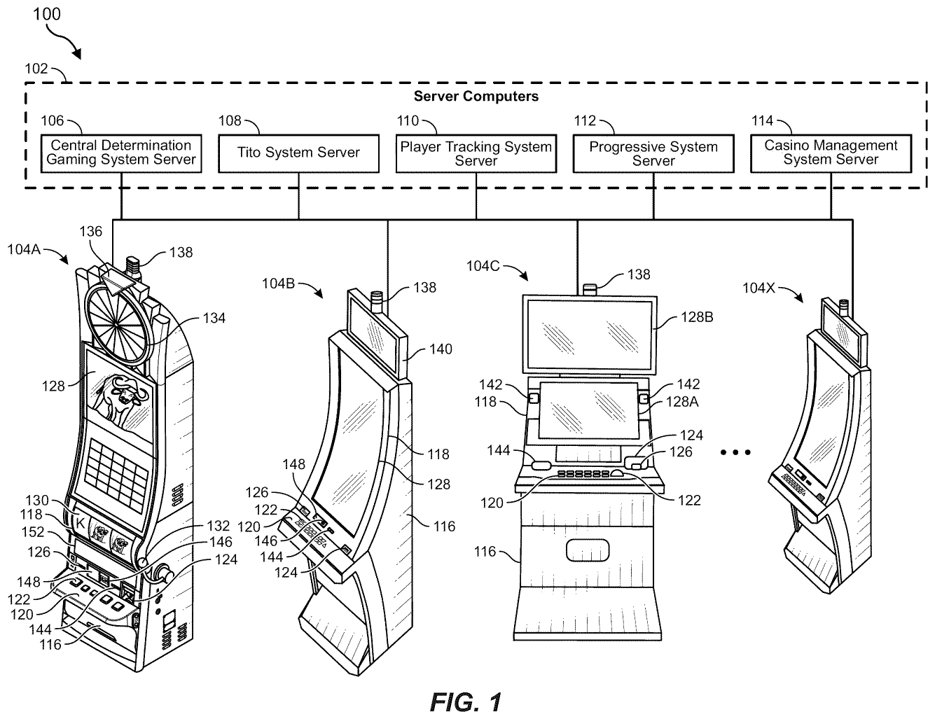

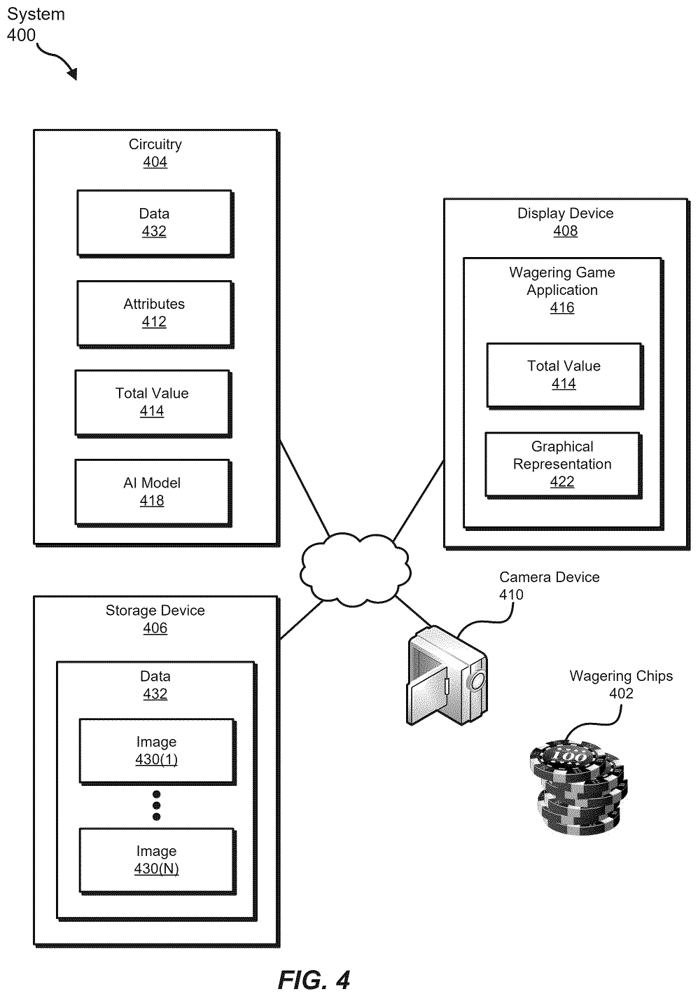

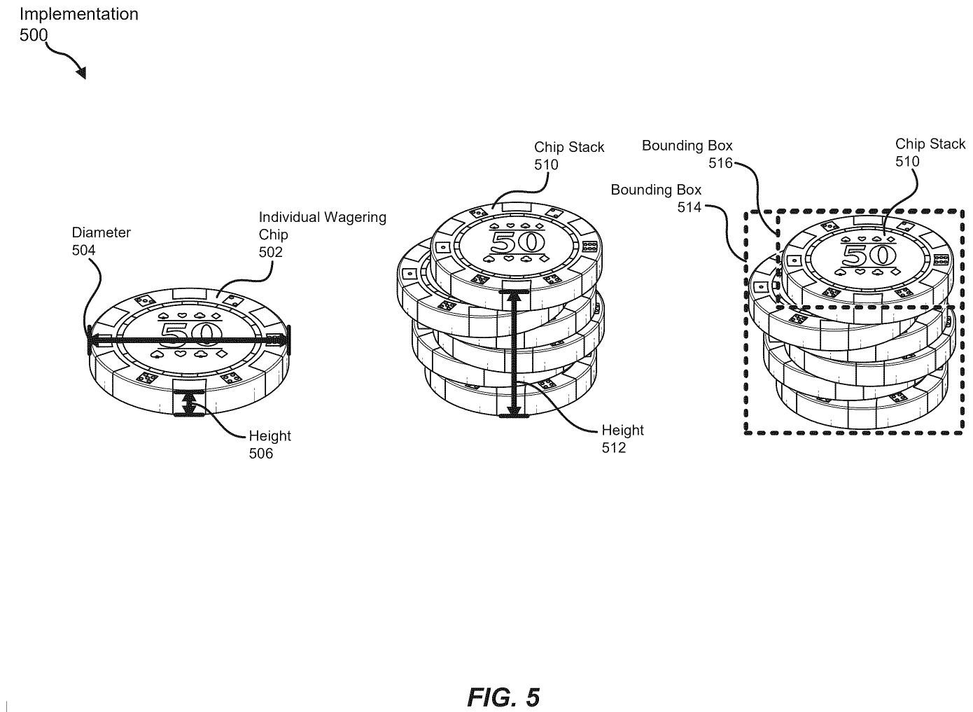

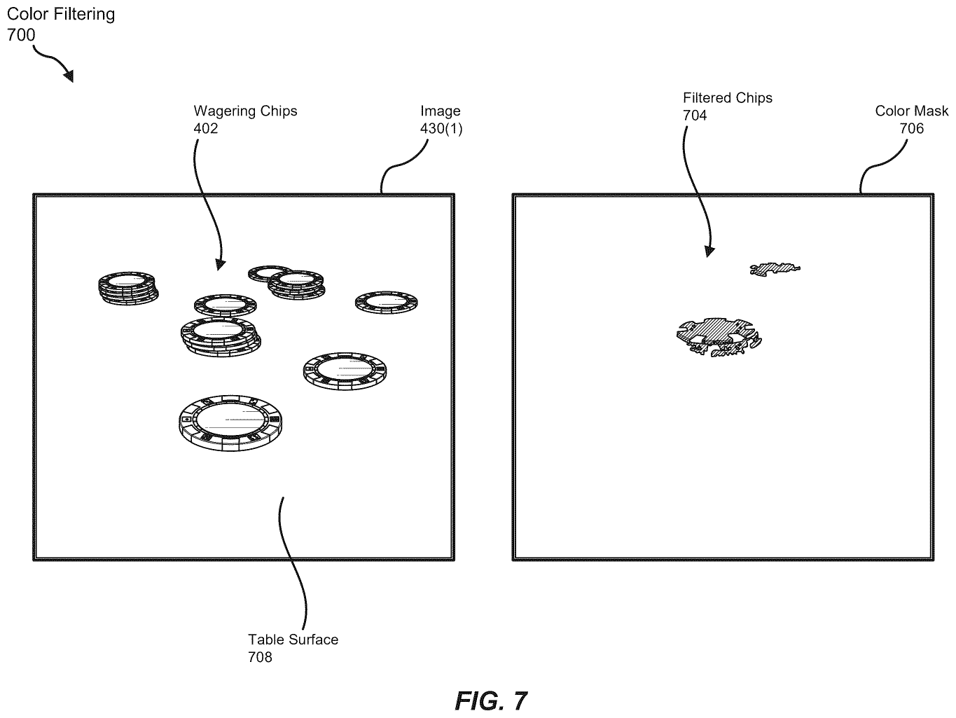

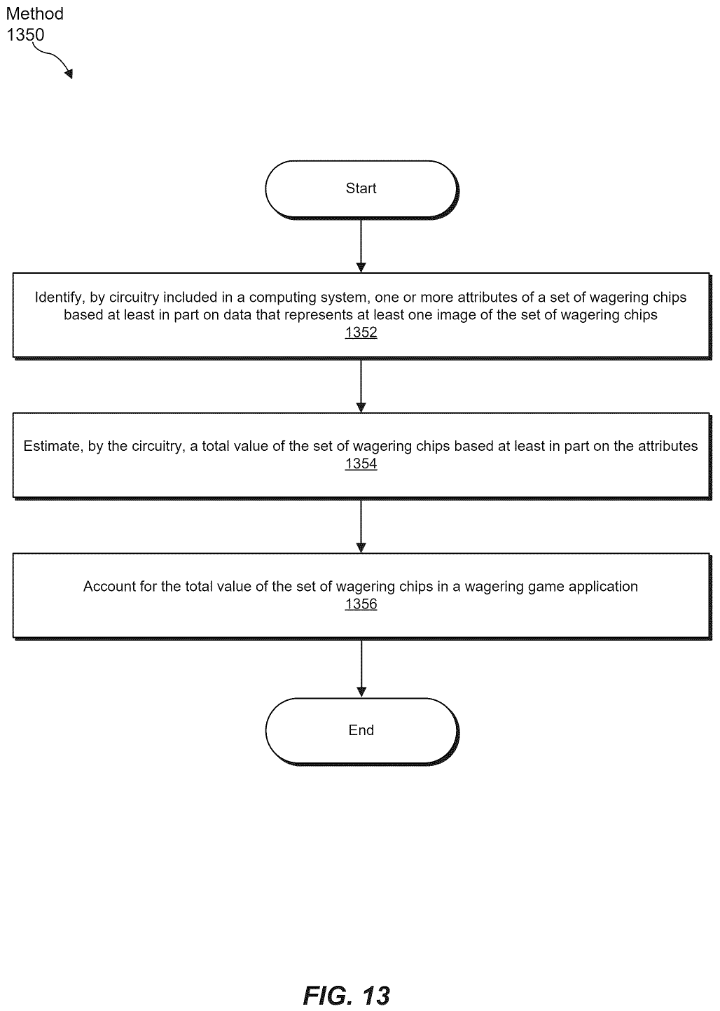

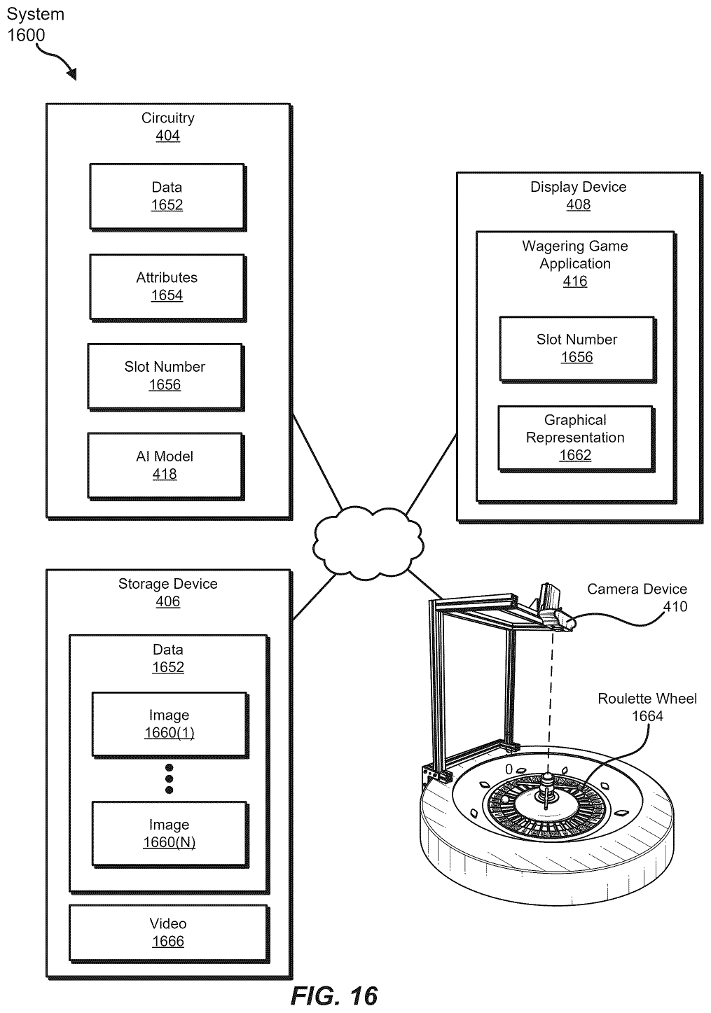

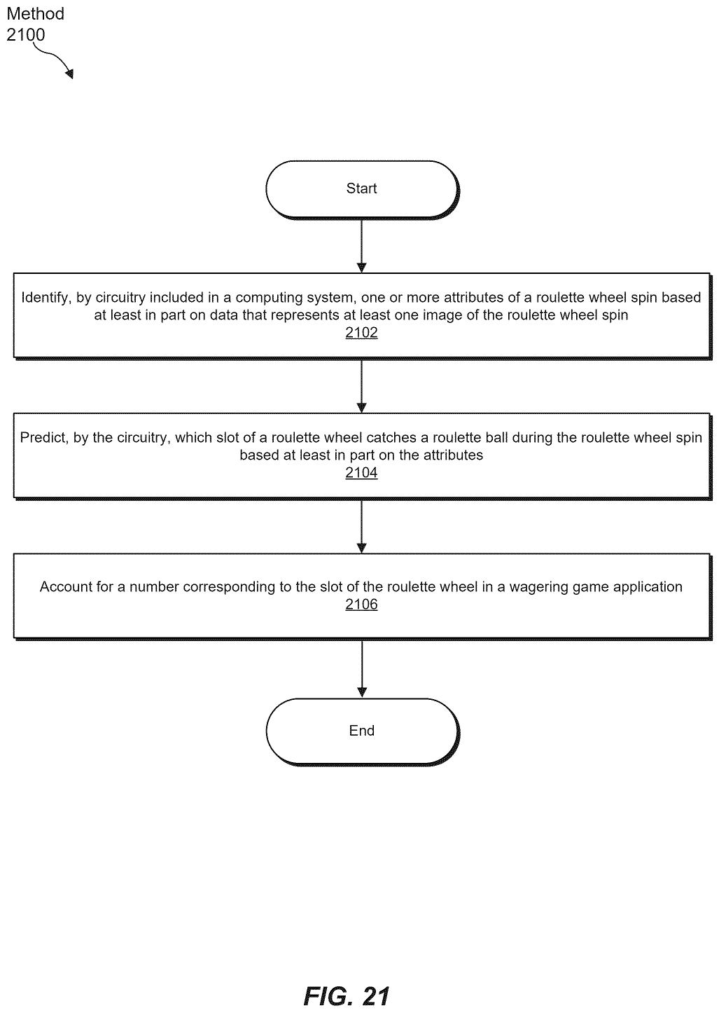

The following will provide, with reference to FIGS. 1-3, detailed descriptions of exemplary systems and/or devices capable of facilitating and/or carrying out any of the various detection embodiments described herein. The following will also provide, with reference to FIGS. 4-12, detailed descriptions of exemplary apparatuses, devices, systems, components, and corresponding configurations or implementations for detecting sets of wagering chips for wagering game applications. Similarly, the following will provide, with reference to FIGS. 16-20, detailed descriptions of exemplary apparatuses, devices, systems, components, and corresponding configurations or implementations for detecting winning roulette numbers for wagering game applications. Detailed descriptions of methods for detecting sets of wagering chips for wagering game applications will be provided in connection with FIG. 13-15, and detailed descriptions of methods for detecting winning roulette numbers for wagering game applications will be provided in connection with FIG. 21.

[Inventor(s): The Following Section is Boilerplate and does not Require Your Review]

FIG. 1 illustrates several different models of EGMS which may be networked to various gaming related servers. Shown is a system 400 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A. 104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 1048 or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket out (TITO) system server 108, a player tracking system server 110, a progressive server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area of burton deck 120 accessible by a player that is configured with input switches or buttons 122, an access channel for a bill validator 124, and/or an access channel for a ticker-out printer 126.

In FIG. 1, gaming device 104A is shown as a Relm XLTM model gaming device manufactured by Aristocrat® Technologies, Inc. As shown, gaming device 104A is a reel machine having a gaming display area 118 comprising a nu er (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically co rolled video monitor.

In some implementations, the bill validator 124 may also function as a “ticket. In” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementation a game controller within the gaming device 104A can communicate with the player tracking system server 110 to send and receive play t tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of a award may be needed.

There may also be one or more information panels 152 which may be a back-11t, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

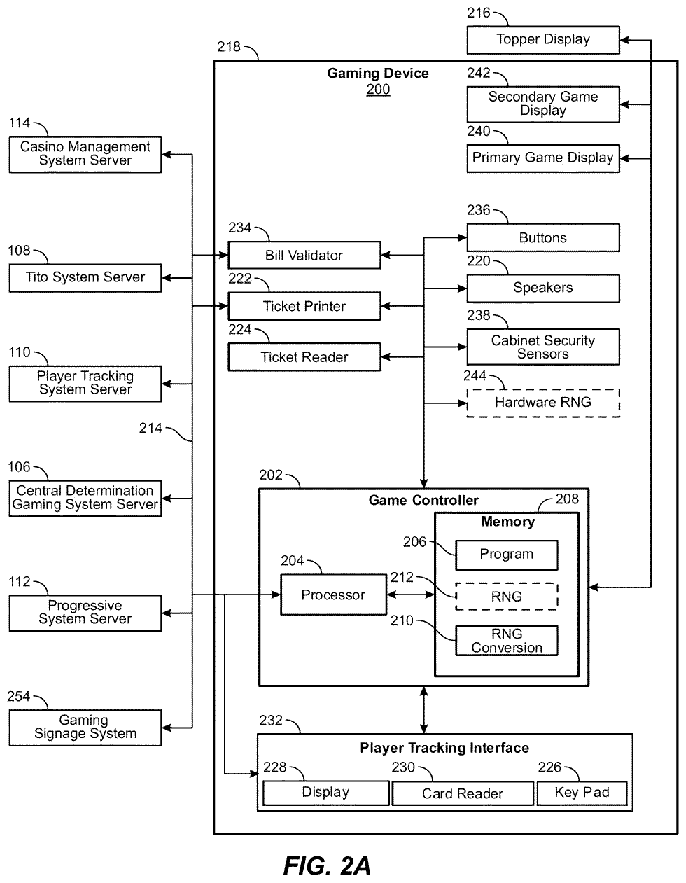

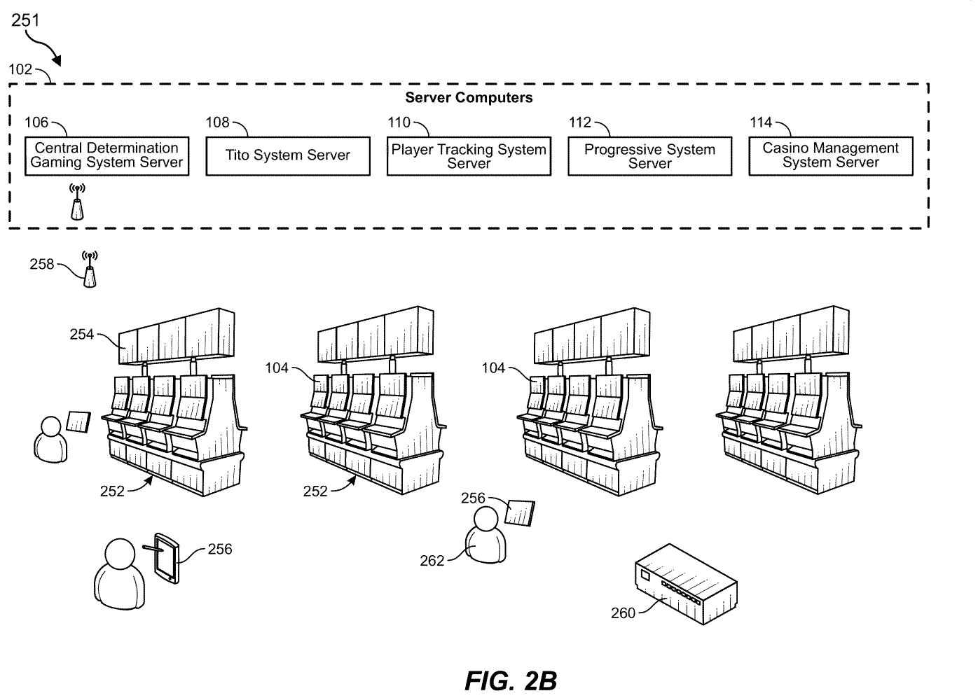

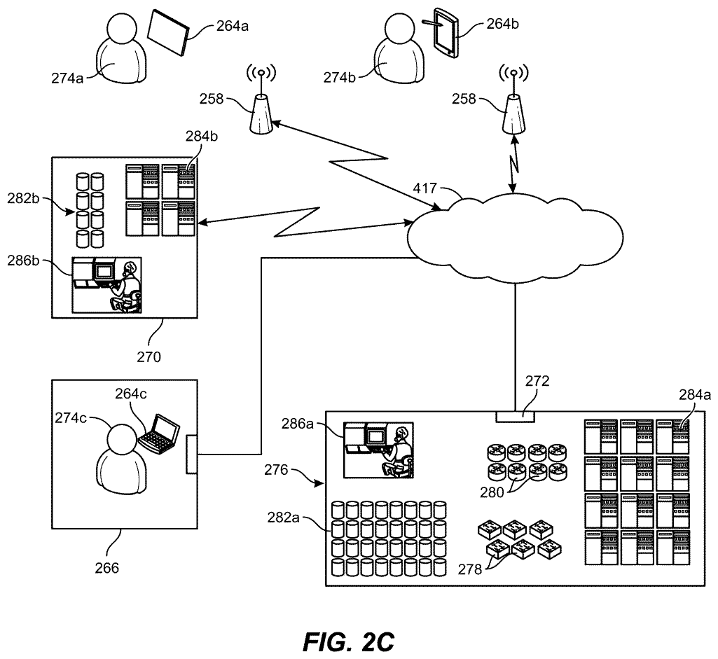

Many or all the above-described components can be controlled by circuitry (e.g., a game controller) housed inside the main cabinet 116 of the gaming device 104A, the details of which shown in FIG. 2A.

An alternative example gaming device 104B. Illustrated in FIG. 1 is the ArcTM model gaming device manufactured by Aristocrat® Technologies, Inc. Note that where possible, reference numerals identifying similar features of the gaming device 104A implementation are also identified in the gaming device 1048 implementation using the same reference numbers. Gaming device 1048 does not include physical reels and instead shows game play functions on main display 128. An optional topper screen 140 may be used as a secondary game display for bonus play, to show fame features or attraction activities while a game is not in play, or any other information or media desired by the game design or operator. In some implementations, the optional topper screen 140 may also or alternatively be used to display progressive jackpot prizes available to a player during play of gaming device 1048.

Example gaming device 1048 includes a main cabinet 116 including a main door which opens to provide access to the interior of the gaming device 1048 The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive live, bonus games, and may be deployed for operation in Class 2 or Class 3, etc.

RIG. 2A is a block diagram depicting exemplary internal electronic components of a gaming device 200 connected to various external systems. All of parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a screen, etc.) that sits above cabinet 218 Cabinet 218 or topper display 216 may also house a number of other components which may be used to add features to a game being played on gaming device 200, including speakers 220, a ticket printer 222 which prints bar-coded tickets or other media or mechanisms for storing of indicating a player's credit value, a ticket reader 224 which reads bar-coded tickets or other media of mechanisms for storing of indicating a player's credit value, and a player tracking interface 232 Player tracking interface 232 may include a keypad 226 for entering information, a player tracing display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO sys 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors Although FIG. 2A illustrates that game controller 202 includes a single processor 204, game controller 202 is not limited to this representation and instead can include multiple processors 204 (e.g., two or more processors).

FIG. 2A Illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random ess memory (RAM), read-only memory (ROM), hard disk drives, solid state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A Illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stared another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include. (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as central determination gaming system server 106 (not shown in FIG. 2A but shown in FIG. 1). For purpose of this disclosure, the term “game instance” refers to a play or a round of a game that gaming device 200 presents (e.g., via a user interface (UI) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200. (2) the harsh environment in which gaming devices 200 operate, (3) security requirements, (4) fault tolerance requirements, and (5) the requirement for additional special purpose componentry enabling functionality of an EGM. These difference substantial engineering effort with respect to game design implementation, game mechanics, hardware components, and software.

One regulatory requirement for games running on gaming device 200 generally involves complying with a certain level or randomness. Typically, gaming jurisdictions mandate that gaming devices 200 satisfy a minimum level of randomness without specifying how a gaming device 200 should achieve this level or randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNs operating on gaming device 200. More generally, an output of the RNG 212 can be the basis on which game outcomes are determined by game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates ANG outcomes. Analogous to RNG 212, hardware RNG 244 performs specialized and non-generic operations in order to comply with regulatory and gaming requirements. For example, because of regulation requirements, hardware ANG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212 RNG 212 may utilize the RNG outcomes from hardware ANG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate the gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower out most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulator requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize layout amounts. The RNG conversion engine 210 could utilize one lookup table to map the RNG outcome to a outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g. to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during the course of gameplay (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communication with gaming devices A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. ZA) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 28 depicts a casino gaming environment according to one example. In this example, the casino 251 includes banks 252 of EGMs 104. In this example, each bank 252 of EGMs 104 includes a corresponding age system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial a count corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements gaming devices shown in FIG. 2C are merely shown by way of example. In this example, various gaming devices, including but not limited to end er devices (EUDs) 264a, 264b and 264c are capable of communication via one or more networks 417. The networks 417 may, for example, include one or more cellular telephone networks, the internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 284a, servers 284a and one or more workstations 270a. The servers 284a may, for example, be configured to provide access to a library of games for online game play. In some examples, code for executing at least some of the games may initially be stored on one or more of the storage device 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286a. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” Instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication formation, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

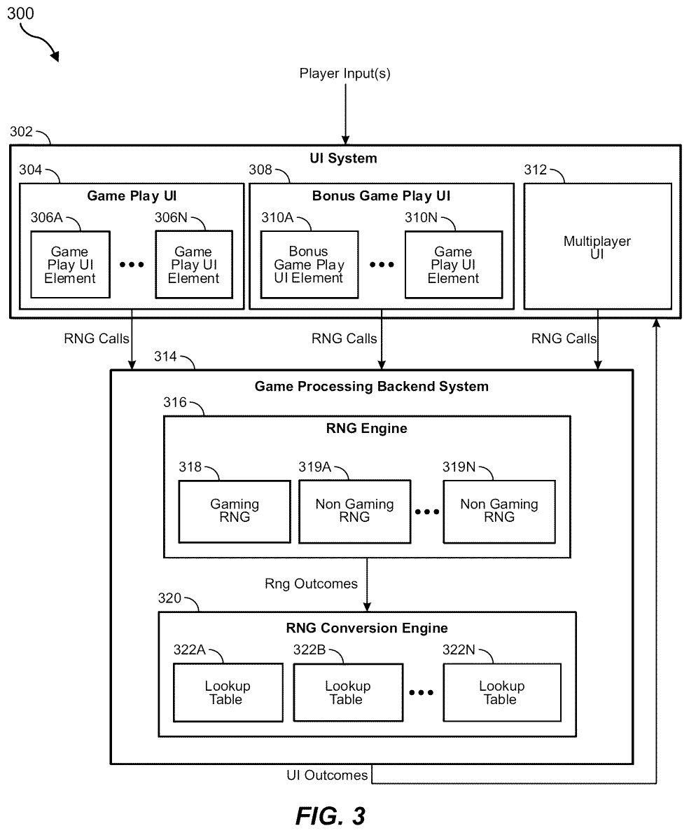

FIG. 3 illustrates, in block diagram form, an implementation of a game processing architecture 300 that implements a game processing pipeline for the play of a game in accordance various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user in a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI elements 306A. 306N are similar to the bonus game play UI elements 310A-310N. In other implementations, the game play UI elements 306A-306N can differ from the bonus game play UI elements 3108-310N.

FIG. 3 also illustrates that UI system 302 could include a multiplayer UI 312 purposed for game play that differs or is separate from the typical game. For example, multiplayer UI 312 could be set up to receive player inputs and/or present game play information relating to a tournament mode. When a gaming device transitions from a primary game mode that presents the base game to a tournament mode, a single gaming device is linked and synchronized to other gaming devices to generate a tournament outcome. For example, multiple RNG engines 315 corresponding to each gaming device could be collectively linked to determine a tournament outcome. To enhance player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 included UI elements, multiplayer UI 312 could also include one or more multiplayer UI elements.

Based on the player inputs, the UI system 302 could generate RNG calls to a game processingg backend system 314. As an example, the UI system 302 could use one or more application programming interfaces (APIs) to generate the RING calls. To process the RNG calls, the RNG engine 316 could utilize gaming ANG 318 and/or non-gaming ANGs 319A-319N. Gaming RNG 318 could correspond to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to the outcomes for non-gaming purposes. As an example, non-gaming RNGs 319A-319N can generate random numbers for generating messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts Different lookup tables could be utilized depending on the different game modes, for example, a base game versus a bonus game.

After generating the UI outcome, the game process backend system 314 sends the UI outcome to the UI system 302. Examples of UI outcomes are symbols to display on video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

### [End of Boilerplate]

FIG. 4 illustrates an exemplary system 400 for detecting and/or accounting for features of wagering games. As illustrated in FIG. 1, system 400 may include and/or represent circuitry 404, a storage device 406, a display device 408, and/or camera device 410. In some examples, system 400 may be deployed and/or implemented in an environment (e.g., a casino, a security room, a recording studio, etc.) where at least a portion of a real-world table game (e.g., poker, blackjack, roulette, craps, etc.) is played.

In some examples, circuitry 404 may be communicatively coupled to storage device 406, display device 408, and/or camera device 410 via direct and/or indirect connections. In one example, camera device 410 may take and/or capture one or more images 430(1)-(N) of wagering chips 402 as video or stills. In this example, camera device 410 may transmit, send, and/or communicate images 430(1)-(N) of wagering chips 402 to circuitry 404, storage device 406, and/or display device 408.

In some examples, storage device 406 may store, maintain, and/or save images 430(1)-(N) as data 432. In one example, circuitry 404 may identify one or more attributes 412 of wagering chips 402 based at least in part on the image represented in data 432. Examples of attributes 412 include, without limitation, a stacked configuration of wagering chips 402, an unstacked configuration of wagering chips 402, a scattered or disarrayed configuration of wagering chips 402, colors of wagering chips 402, values of wagering chips 402, dimensions (e.g., height, diameter, etc.) of wagering chips, dimensions (e.g., height, etc.) of a stack composed of wagering chips 402, angles of wagering chips 402 relative to an image plane in images 430(1)-(N), combinations or variations of one or more of the same, portions of one or more of the same, and/or any other suitable attributes.

In some examples, wagering chips 402 may be configured, arranged, and/or constructed in a stack. In one example, circuitry 404 may measure, approximate, and/or estimate one or more dimensions of the stack based at least in part on images 430(1)-(N) represented in data 432. In this example, circuitry 404 may calculate, compute, and/or estimate a total value 414 based at least in part on the dimensions of the stack. In certain implementations, each chip included in wagering chips 402 may correspond to, constitute, and/or represent a certain monetary value and/or credit. In such implementations, total value 414 may correspond to, constitute, and/or represent a sum of all the monetary values and/or credits associated with wagering chips 402.

In some examples, circuitry 404 may calculate, compute, and/or estimate a total value 414 of wagering chips 402 based at least in part on attributes 412. In one example, circuitry 404 may account for and/or apply total value 414 of wagering chips 402 in a wagering game application 416. Wagering game application 416 may include and/or represent any of a variety of applications, programs, and/or features. Examples of wagering game application 416 include, without limitation, security system application, a television application, a streaming application, an online gaming application, a bet-verification application, combinations or variations of one or more of the same, portions of the one or more of the same, and/or any other suitable wagering game applications.

In some examples, circuitry 404 may execute and/or implement computer-vision technology that relies on and/or incorporates an AI model 418. In one example, circuitry 404 may identify and/or determine attributes 412 of wagering chips 402 via AI model 418 based at least in part on data 432. Examples of AI model 418 include, without limitation, machine learning models, deep learning models, convolutional neural networks, recurrent neural networks, supervised learning models, artificial neural networks, unsupervised learning models, linear regression models, logistic regression models, decision trees, support vector machine models, Naive Bayes models, k-nearest neighbor models, k-means models, random forest models, combinations or variations of one or more of the same, and/or any other suitable AI models.

As a specific example, AI model 418 may include and/or represent a convolutional neural network that involves various layers, such as one or more convolution layers, activation layers, pooling layers, and fully connected layers. In this example, circuitry 404 may pass all or a portion of data 432 through the convolutional neural network to detect, compute, and/or estimate total value 414 of wagering chips 402.

In the convolutional neural network, all or a portion of data 432 may first encounter the convolution layer. At the convolution layer, all or a portion of data 432 may be convolved using a filter and/or kernel. In particular, the convolution layer may cause circuitry 404 to slide a matrix function window over and/or across all or a portion of data 432. Circuitry 404 may then record the resulting data convolved by the filter and/or kernel. In one example, one or more nodes included in the filter and/or kernel may be weighted by a certain magnitude and/or value.

After completion of the convolution layer, the convolved representation of all or a portion of data 432 may encounter the activation layer. At the activation layer, the convolved data may be subjected to a non-linear activation function. In one example, the activation layer may cause circuitry 404 to apply the non-linear activation function to the convolved data. By doing so, circuitry 404 may be able to identify and/or learn certain non-linear patterns, correlations, and/or relationships between different regions of the convolved data.

In some examples, circuitry 404 may apply one or more of these layers included in the convolutional neural network to all or a portion of data 432 multiple times. As such data completes all the layers, the convolutional neural network may render an estimation, calculation, and/or classification of wagering chips 402 based at least in part on data 432. In one example, the estimation, calculation, and/or classification may indicate and/or identify total value 414 of wagering chips 402.

In some examples, AI model 418 may be trained and/or constructed with training data that includes various samples. Examples of such training data include, without limitation, images of an individual wagering chips captured at different angles, images of individual wagering chips captured at different rotations, images of individual wagering chips of different colors, images of stacks of wagering chips with different combinations of colors, images of stacks of wagering chips with different orders of color combinations, images of wagering chips with different sizes and/or dimensions, images of wagering chips from different manufacturers and/or vendors, combinations or variations of one or more of the same, portions of one or more of the same, and/or any other suitable training data.

In some examples, AI model 418 may be trained by circuitry 404. In other examples, AI model 418 may be trained by another computing device—whether inside or outside of system 400. In one example, AI model 418 may be trained in the same environment (e.g., the same casino, the same security room, the same recording studio, etc.) as at least a portion of the real-world table game (e.g., poker, blackjack, roulette, craps, etc.) is played. For example, AI model 418 may be trained on images captured from the same game table or a similar game table as the one used for the real-world table game. Additionally or alternatively, AI model 418 may be trained on images captured from various game tables—whether inside or outside of the environment where the real-world table game is played.

In some examples, the computer-vision technology executed and/or implemented by circuitry 404 may involve various functions. For example, the computer-vision technology may involve and/or perform image classification in which the types or classes of objects represented and/or captured in images 430(1)-(N) is predicted. In another example, the computer-vision technology may involve and/or perform object localization in which the locations of such objects are identified and/or indicated in images 430(1)-(N). In a further example, the computer-vision technology may involve and/or perform object detection in which a bounding box is applied to and/or overlaid atop one or more of such objects and/or in which certain objects are differentiated from one another by type or class. Additionally or alternatively, the computer-vision technology may involve and/or perform instance segmentation in which the distinct objects are segmented and/or delineated from one another.

In some examples, circuitry 404 may include and/or represent one or more electrical and/or electronic circuits capable of processing, applying, modifying, transforming, displaying, transmitting, receiving, and/or executing data for system 400. In one example, circuitry 404 may access and/or analyze data 432 stored in storage device 406 to facilitate and/or support detecting and/or verifying the total value of wagering chips 402. Additionally or alternatively, circuitry 404 may launch, perform, and/or execute certain executable files, code snippets, and/or computer-readable instructions to facilitate and/or support implementing and/or displaying wagering game application 416. In certain implementations, circuitry 404 may provide display device 408 with instructions and/or commands that, upon execution, cause display device 408 to present and/or display a graphical representation of wagering game application 416 and/or a graphical representation 422 of total value 414.

Although illustrated as a single unit in FIG. 4, circuitry 404 may include and/or represent a collection of multiple processing units and/or electrical or electronic components that work and/or operate in conjunction with one another. In one example, circuitry 404 may include and/or represent a central processing unit (CPU) and/or a graphics processing unit (GPU). In another example, circuitry 404 may include and/or represent an application-specific integrated circuit (ASIC). Additionally or alternatively, circuitry 404 may be included and/or incorporated in a server and/or one or more client devices of system 400 (not necessarily illustrated in FIG. 1). Examples of circuitry 404 include, without limitation, processing devices, microprocessors, microcontrollers, GPUs, CPUs, ASICs, field-programmable gate arrays (FPGAs), systems on chips (SoCs), parallel accelerated processors, tensor cores, integrated circuits, chiplets, optical modules, receivers, transmitters, transceivers, storage devices, memory devices, logical circuitry, portions of one or more of the same, variations or combinations of one or more of the same, and/or any other suitable circuitry.

In some examples, storage device 406 may include and/or represent any type or form of volatile or non-volatile memory device or medium capable of storing data and/or computer-readable instructions. In one example, storage device 406 may store, load, and/or maintain certain modules, data, and/or computer-readable instructions executed and/or used by circuitry 404. Examples of storage device 406 include, without limitation, random access memory (RAM), read only memory (ROM), flash memory, hard disk drives (HDDs), solid-state drives (SSDs), optical disks, caches, buffers, variations or combinations of one or more of the same, portions of one or more of the same, and/or any other suitable storage devices.

In some examples, display device 408 may include and/or represent any type or form of output device that presents visual, audio, and/or tactile information. Examples of display device 408 include, without limitation, monitors, televisions, liquid crystal displays (LCDs), plasma displays, light emitting diode (LED) displays, organic LED (OLED) panels, cathode-ray tube (CRT) displays, laser displays, audio transducers or speakers, tactile displays, variations or combinations of one or more of the same, portions of one or more of the same, and/or any other suitable display devices.

In some examples, camera device 410 may include and/or represent any type or form of instrument that takes and/or captures visual information and/or images. In one example, camera device 410 may include and/or represent a video camera that takes and/or captures video of wagering chips 402. Additionally or alternatively, camera device 410 may include and/or represent a still camera that takes and/or captures still images and/or photographs of wagering chips 402.

FIG. 2 illustrates an exemplary implementation 500 of an individual wagering chip 502 and/or a chip stack 510. In some examples, implementation 500 may include and/or represent certain elements, components, and/or features that perform and/or provide functionalities that are similar and/or identical to those described above in connection with FIG. 1. As illustrated in FIG. 2, individual wagering chip 502 may have, include, and/or be characterized by a diameter 504 and/or a height 506. In one example, chip stack 510 may include and/or represent a set of wagering chips stacked, configured, and/or arranged in a vertical column. In this example, chip stack 510 may have, include, and/or be characterized by a height 512.

In some examples, circuitry 404 may measure, approximate, and/or estimate height 512 of chip stack 510 based at least in part on images 430(1)-(N) represented in data 432. In one example, circuitry 404 may calculate, compute, and/or estimate the total value of chip stack 510 based at least in part on height 506 of individual wagering chip 502 and height 512 of chip stack 510. For example, circuitry 404 may divide height 512 of chip stack 510 by height 506 of individual wagering chip 502 to determine the number of wagering chips included in the chip stack and then assign and/or apply values to each wagering chip included in chip stack 510 according to their respective colors. In this example, circuitry 404 may add and/or sum up the values assigned and/or applied to each of the wagering chips included in chip stack 510 to determine total value 414.

In some examples, circuitry 404 may be programmed and/or configured with information and/or knowledge about the actual height of individual wagering chip 502. In another example, circuitry 404 may obtain and/or receive information and/or data indicating the actual height of individual wagering chip 502. Accordingly, height 506 may be known to circuitry 404. Additionally or alternatively, circuitry 404 may rely on and/or utilize computer vision and/or AI model 418 to determine and/or measure height 506 of individual wagering chip 502 based at least in part on an image taken by camera device 410.

In some examples, circuitry 404 may apply and/or implement a bounding box 516 over and/or around the top wagering chip in chip stack 510 (e.g., via AI model 418). In one example, circuitry 404 may apply and/or implement a bounding box 514 over and/or around chip stack 510 (e.g., via AI model 418). In this example, circuitry 404 may measure, calculate, and/or estimate height 512 by determining the difference between the bottom of the top wagering chip and the bottom of chip stack 510.

In some examples, circuitry 404 may calculate and/or estimate the height of a single wagering chip as captured in images 430(1)-(N). For example, circuitry 404 may identify a set of coordinates (e.g., x-axis coordinates and/or y-axis coordinates relative to the image plane) corresponding to the single wagering chip as captured in images 430(1)-(N). In this example, circuitry 404 may normalize a measurement of diameter 504 based at least in part on such coordinates. Additionally or alternatively, circuitry 404 may multiply the measurement of diameter 504 by the known height of such a wagering chip and then divide the product of that multiplication by the known diameter of such a wagering chip to calculate and/or estimate the height of the single wagering chip as captured in images 430(1)-(N).

In some examples, circuitry 404 may calculate and/or estimate the height of chip stack 510 based at least in part on the height measurement of the single wagering chip. For example, circuitry 404 may calculate and/or estimate the height of chip stack 510 by comparing the height of chip stack 510 to the height of the single wagering chip as captured and/or represented in images 430(1)-(N). In one example, this comparison may involve determining the number of times that the height of the single wagering chip fits inside chip stack 510. Additionally or alternatively, circuitry 404 may rely on and/or implement ratio estimation to calculate and/or estimate the height and/or diameter of wagering chips as perceived in images 430(1)-(N) based at least in part on their known real-world measurements. For example, if a wagering chip's actual height and diameter are 3.25 millimeters (mm) and 40 mm, respectively, circuitry 404 may rely on and/or implement the following ratio estimation formula:

$$\frac{Perceived Height}{Perceived Diameter} \times \frac{Actual Height ( 3.25 mm )}{Actual Diameter ( 40 mm )} .$$

FIG. 3 illustrates an exemplary angled perspective 600 of individual wagering chip 502 as captured and/or represented in the image plane of images 430(1)-(N). As illustrated in FIG. 3, angled perspective 600 may show and/or portray individual wagering chip 502 as being vertically projected relative to the image plane. For example, in angled perspective 600, one side of individual wagering chip 502 may appear elevated and/or raised by a vertical projection 606 relative to the image plane. In some examples, angled perspective 600 may result from and/or be caused by the angle at which camera device 410 takes and/or captures images 430(1)-(N). In one example, circuitry 404 may adjust and/or compensate the height measurement of individual wagering chip 502 in view of and/or based at least in part on angled perspective 600.

In some examples, circuitry 404 may adjust and/or modify the height measurement of individual wagering chip 502 in images 430(1)-(N) to compensate for angled perspective 600. For example, circuitry 404 may identify and/or determine a set of coordinates (e.g., x-axis coordinates and/or y-axis coordinates relative to the image plane) corresponding to individual wagering chip 502 as captured in images 430(1)-(N). In one example, circuitry 404 may normalize an angle measurement of individual wagering chip 502 based at least in part on that set of coordinates. For example, the angle measurement of individual wagering chip 502 may be calculated and/or represented by

$$θ = {sin}^{- 1} ( \frac{Vertical Projection 306}{Diameter 204} ) .$$

In some examples, to calculate and/or estimate the adjusted height measurement of individual wagering chip 502, circuitry 404 may multiply the initial height measurement of individual wagering chip 502 by a sine function involving the angle measurement. In one example, the sine function may involve and/or take the difference between half of pi and θ. For example, the adjusted height measurement of individual wagering chip 502 may be calculated and/or represented by

$$adjusted height = height \times sin ( \frac{π}{2} - θ ) = height \times sin ( \frac{π}{2} - {sin}^{- 1} ( \frac{Vertical Projection 306}{Diameter 204} ) ) .$$

In this example, the adjusted height measurement may correspond to and/or represent an adjusted height 604 of individual wagering chip 502. In certain implementations, circuitry 404 may count the total number of wagering chips included in chip stack 510 based at least in part on adjusted height 604.

FIG. 4 illustrates exemplary color filtering 700 performed by circuitry 404. As illustrated in FIG. 4, exemplary color filtering 700 may include and/or represent image 430(1) and/or a color mask 706 applied to image 430(1). In some examples, image 430(1) may show and/or portray wagering chips 402 scattered and/or strewn across a table surface 708. For example, in image 430(1), wagering chips 402 may be shown and/or portrayed in an unstacked and/or unorganized configuration. In one example, circuitry 404 may filter and/or distinguish wagering chips 402 by their respective colors. In this example, circuitry 404 may apply and/or implement a color mask 706 on wagering chips 402 shown and/or portrayed in image 430(1). By applying and/or implementing color mask 706 in this way, circuitry 404 may identify and/or distinguish those of wagering chips 402 that are composed of a specific color.

In some examples, circuitry 404 may apply and/or implement a series of different color masks on wagering chips 402 to filter all of wagering chips 402 by different colors (e.g., blue, green, red, white, black, etc.). In one example, circuitry 404 may identify and/or distinguish filtered chips 704 from the rest of those in wagering chips 402 based at least in part on color mask 706. For example, filtered chips 704 may include and/or represent all of the red wagering chips shown and/or portrayed in image 430(1). In this example, circuitry 404 may apply and/or implement color mask 706 on image 430(1) to identify and/or distinguish all the red wagering chips shown and/or portrayed in image 430(1). Additionally or alternatively, circuitry 404 may apply and/or implement additional color masks on image 430(1) to identify and/or distinguish all the blue, green, white, and/or black wagering chips shown and/or portrayed in image 430(1).

In some examples, circuitry 404 may assign and/or apply a specific value to each of the red wagering chips shown and/or portrayed in image 430(1). In one example, circuitry 404 may assign and/or apply values to each of the blue, green, white, and/or black wagering chips shown and/or portrayed in image 430(1) in accordance with their respective colors. In this example, circuitry 404 may estimate, calculate, and/or determine the total value of wagering chips 402 based at least in part on the different values assigned and/or applied to wagering chips 402 according to their respective colors.

In some examples, circuitry 404 may identify and/or distinguish filtered chips 704 by color from the rest of wagering chips 402 based at least in part on their hue, light intensity (sometimes referred to value), and/or color saturation. Additionally or alternatively, circuitry 404 may identify and/or distinguish the rest of wagering chips 402 by color based at least in part on their hue, light intensity (sometimes referred to value), and/or color saturation. In certain implementations, circuitry 404 may perform such color filtering of wagering chips 402 via AI model 418.

In some examples, circuitry 404 may identify wagering chips 402 as being in an unstacked and/or unorganized configuration in image 430(1). In one example, circuitry 404 may segment, delineate, and/or parse wagering chips 402 by color. For example, circuitry 404 may segment, delineate, and/or parse blue, green, red, white, and/or black wagering chips in image 430(1) into individual graphical representations. In this example, circuitry 404 may then create and/or construct a virtual stack of wagering chips 402 by pasting and/or piling the individual graphical representations atop of one another in a stacked configuration. In certain implementations, circuitry 404 may incorporate and/or implement such a virtual stack in wagering game application 416.

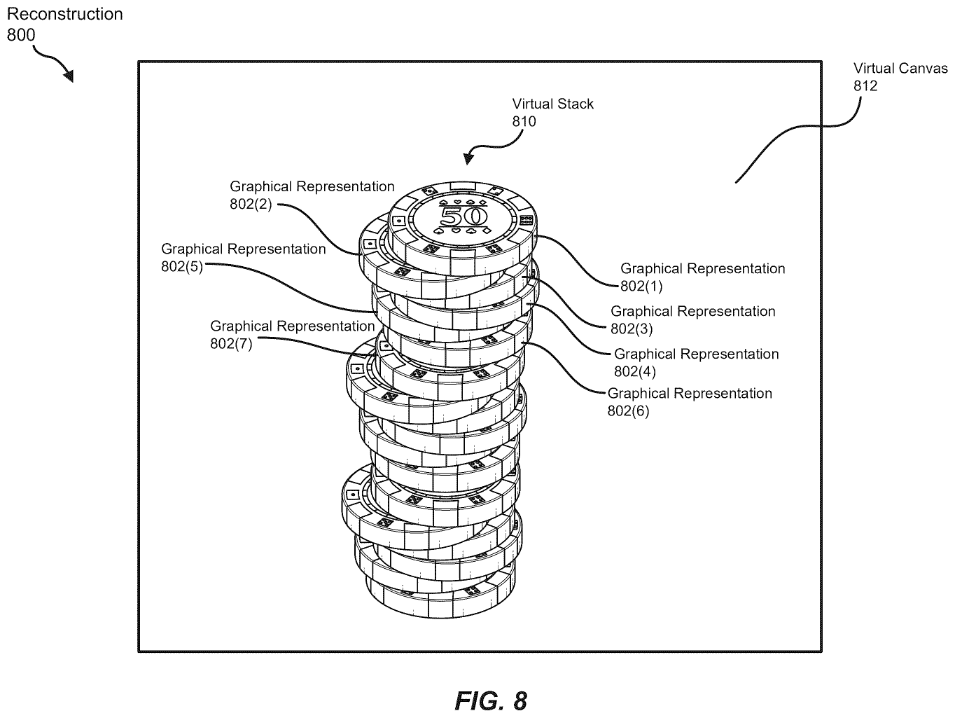

FIG. 8 illustrates an exemplary reconstruction 800 of a virtual stack 810 of wagering chips 402 pasted atop of one another in a stacked configuration. As illustrated in FIG. 8, exemplary reconstruction 800 may include and/or represent virtual stack 810 and/or a virtual canvas 812. In some examples, virtual stack 810 may include graphical representations 802(1), 802(2), 802(3), 804(4), 804(5), 804(6), and/or 804(7) of wagering chips 402 arranged and/or organized in a stacked configuration. In one example, circuitry 404 may create and/or construct virtual stack 810 by pasting and/or piling graphical representations 802(1), 802(2), 802(3), 804(4), 804(5), 804(6), and/or 804(7) atop of one another in a stacked configuration.

In some examples, circuitry 404 may standardize and/or normalize one or more dimensions (e.g., overall size, height, length, width, diameter, etc.) of wagering chips 402 included in virtual stack 810 against virtual canvas 812. In one example, virtual canvas 812 may include and/or represent an image backdrop and/or a digital backdrop. Additionally or alternatively, circuitry 404 may count, add up, and/or sum up the total number and/or total value of wagering chips 402 included and/or represented in virtual stack 810.

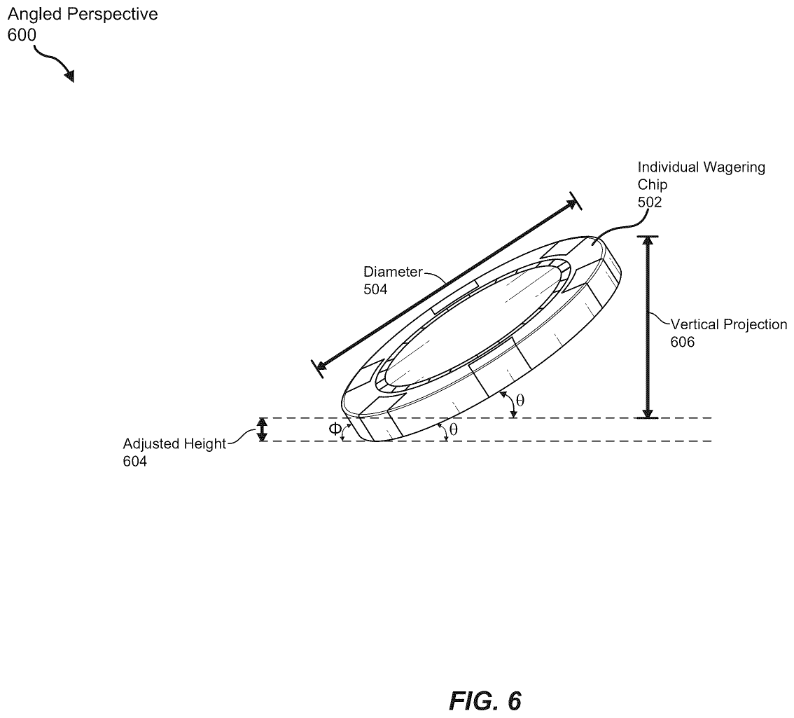

FIG. 6 illustrates an exemplary implementation 900 of different features and/or functions of the models included in and/or represented by AI model 418. In some examples, AI model 418 may include and/or represent an image classification model that enables circuitry 404 to predict and/or classify a type or class of object represented and/or captured in an image. For example, circuitry 404 may execute and/or implement the image classification model to predict and/or classify the object in image classification 902 as a wagering chip 912. In certain implementations, circuitry 404 may apply the image classification model to or on images that include and/or show only a single object (e.g., wagering chip 912).

In some examples, AI model 418 may include and/or represent an object localization model that enables circuitry 404 to detect and/or identify the location of the object in the image. For example, circuitry 404 may execute and/or implement the object localization model to detect and/or identify the location of wagering chip 912 in object localization 904. In this example, circuitry 404 may also execute and/or implement the object localization model to apply and/or overlay a bounding box 914 around wagering chip 912 in object localization 904. In certain implementations, circuitry 404 may apply the object localization model to or on images that include and/or show only a single object (e.g., wagering chip 912).

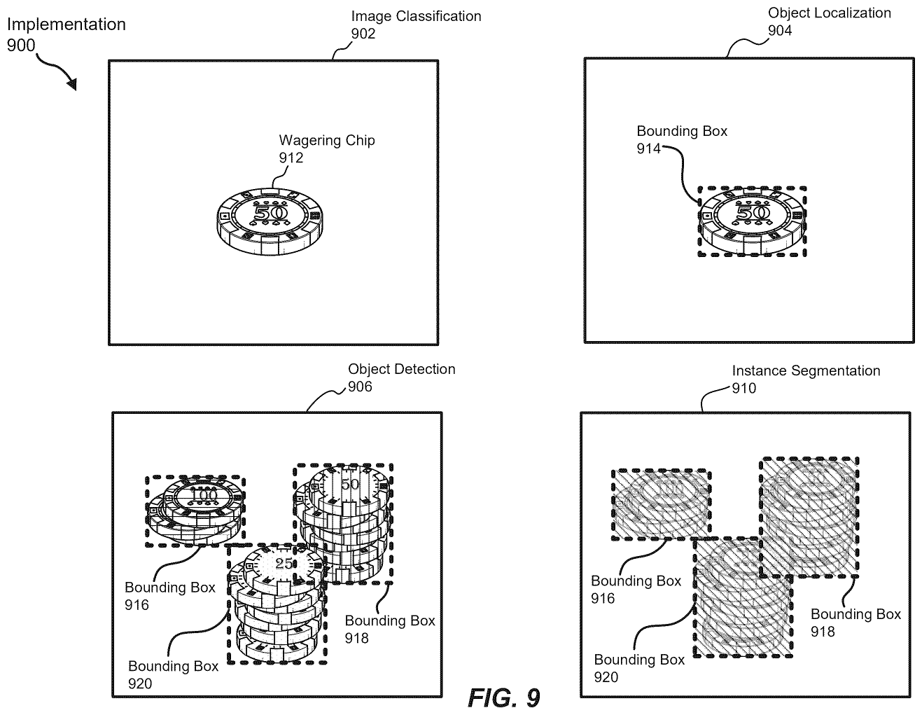

In some examples, AI model 418 may include and/or represent an object detection model that differentiates multiple objects shown in an image by type or class and/or applies or overlays bounding boxes around such objects. For example, circuitry 404 may execute and/or implement the object detection model to differentiate multiple chip stacks from one another by type or class (e.g., chip values, etc.) in object detection 906. In this example, circuitry 404 may also execute and/or implement the object detection model to apply or overlay bounding boxes 916, 918, and 920 around such chip stacks in object detection 906. Although object detection 906 in FIG. 9 involves applying bounding boxes around different chip stacks, other embodiments may additionally or alternatively involve applying bounding boxes around each chip included in those chip stacks. In certain implementations, circuitry 404 may apply the object detection model to or on images that include and/or show multiple objects (e.g., multiple chips and/or multiple chip stacks).

In some examples, AI model 418 may include and/or represent an instance segmentation model that segments and/or delineates the distinct instances of such objects from one another. For example, circuitry 404 may execute and/or implement the instance segmentation model to segment and/or delineate the multiple chip stacks from one another in instance segmentation 910. Although instance segmentation 910 in FIG. 6 involves segmenting and/or delineating different chip stacks from one another, other embodiments may additionally or alternatively involve segmenting and/or delineating each chip included in those chip stacks from one another. In certain implementations, circuitry 404 may apply the instance segmentation model to or on images that include and/or show multiple objects (e.g., multiple chips and/or multiple chip stacks).

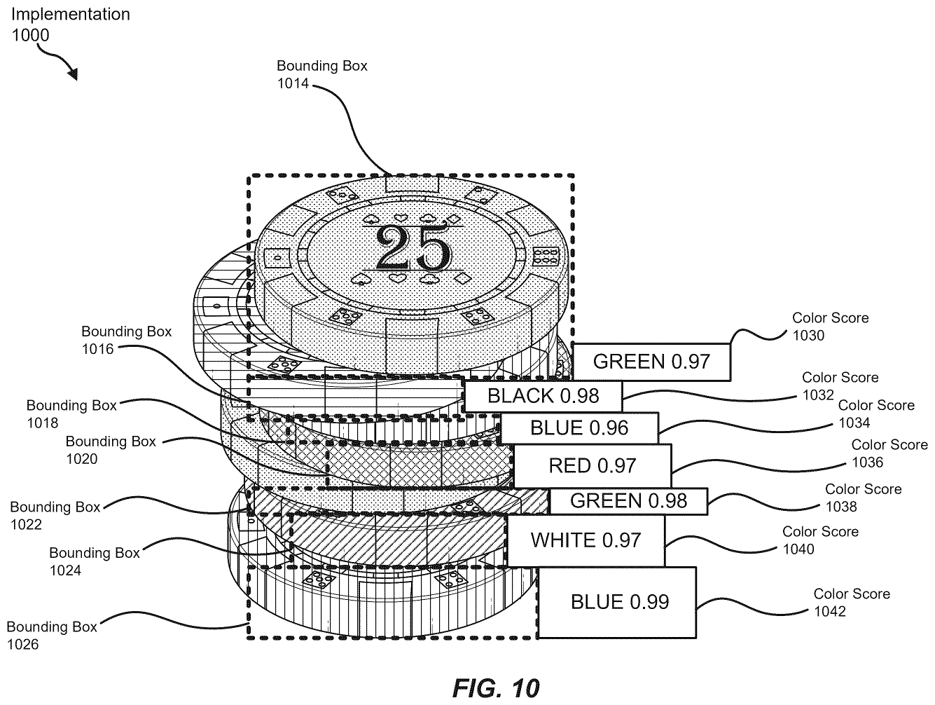

FIG. 10 illustrates an exemplary implementation 1000 of one or more features included in and/or represented by AI model 418. In some examples, implementation 1000 may involve the object detection model and/or the instance segmentation model as applied to a chip stack. For example, circuitry 404 may execute and/or implement the object detection model to differentiate and/or distinguish each chip included in the chip stack by type or class (e.g., chip values, etc.). In this example, circuitry 404 may also execute and/or implement the object detection model to apply or overlay one of bounding boxes 1014, 1016, 1018, 1020, 1022, 1024, and/or 1026 around some or all of each chip included in the chip stack. Additionally or alternatively, circuitry 404 may execute and/or implement the instance segmentation model to segment and/or delineate each instance of the different chip colors included in the chip stack.

As illustrated in FIG. 10, implementation 1000 may also involve presenting and/or displaying text that indicates the different colors of the chips included in the chip stack as detected and/or identified by AI model 418. For example, circuitry 404 may overlay and/or superimpose text over the image in line with the individual chips included in the chip stack. In this example, the chip stack may include and/or represent seven individual chips, and the text may indicate and/or identify the detected colors of each of those seven chips.

As a specific example, circuitry 404 may overlay and/or superimpose text indicating the colors of those seven chips as green, black, blue, red, green, white, and/or blue in descending order. Additionally or alternatively, circuitry 404 may generate, overlay, and/or superimpose a score that corresponds to and/or represents the probability and/or confidence that the color has been detected and/or identified correctly via AI model 418. For example, circuitry 404 may overlay and/or superimpose a color score 1030, a color score 1032, a color score 1034, a color score 1036, a color score 1038, a color score 1040, and/or a color score 1042 alongside the respective chips. In this example, color score 1030 may identify the color of the chip corresponding to bounding box 1014 as green with a confidence of “0.97,” color score 1032 may identify the color of the chip corresponding to bounding box 1016 as black with a confidence of “0.98,” color score 1034 may identify the color of the chip corresponding to bounding box 1018 as blue with a confidence of “0.96,” color score 1036 may identify the color of the chip corresponding to bounding box 1020 as red with a confidence of “0.97,” color score 1038 may identify the color of the chip corresponding to bounding box 1022 as green with a confidence of “0.98,” color score 1040 may identify the color of the chip corresponding to bounding box 1024 as white with a confidence of “0.97,” and/or color score 1042 may identify the color of the chip corresponding to bounding box 1026 as blue with a confidence of “0.99.”

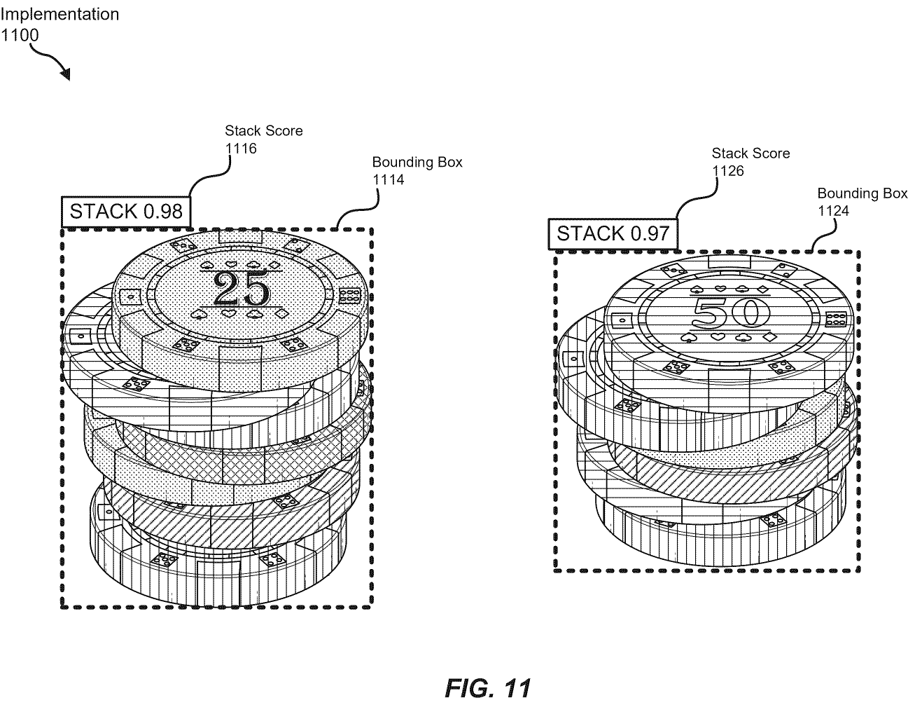

FIG. 11 illustrates an exemplary implementation 1100 of one or more features included in and/or represented by AI model 418. In some examples, implementation 1100 may involve the object detection model and/or the instance segmentation model as applied to two chip stacks. For example, circuitry 404 may execute and/or implement the object detection model to differentiate and/or distinguish the two chip stacks from one another. In this example, circuitry 404 may also execute and/or implement the object detection model to apply or overlay a bounding box 1114 around one of the chip stacks and a bounding box 1124 around the other chip stack.

As illustrated in FIG. 11, implementation 1100 may also involve presenting and/or displaying text that indicates the type or class of objects detected by AI model 418. For example, circuitry 404 may overlay and/or superimpose text over the image (e.g., proximate to bounding boxes 1114 and 1124). In this example, the text may indicate and/or identify the objects detected as chip stacks.

In some examples, circuitry 404 may generate, overlay, and/or superimpose a score that corresponds to and/or represents the probability and/or confidence that the type or class of object has been detected and/or identified correctly via AI model 418. For example, circuitry 404 may overlay and/or superimpose a stack score 1116 proximate to bounding box 1114 and/or a stack score 1126 proximate to bounding box 1124. In this example, stack score 1116 may identify the type or class of object corresponding to bounding box 1114 as a chip stack with a confidence of “0.98,” and/or stack score 1126 may identify the type or class of object corresponding to bounding box 1124 as a chip stack with a confidence of “0.97.”

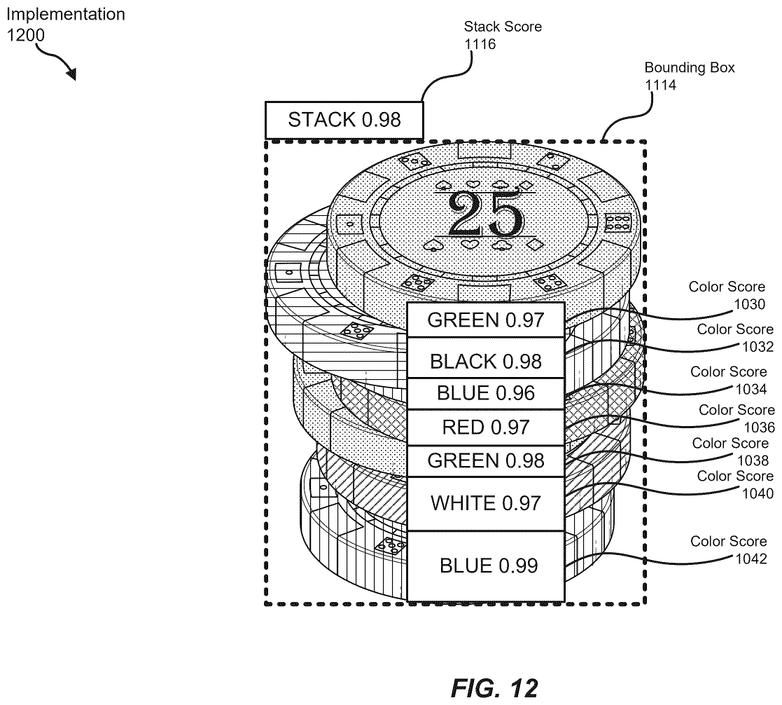

FIG. 12 illustrates an exemplary implementation 1200 of one or more features included in and/or represented by AI model 418. As illustrated in FIG. 12, implementation 1200 may involve presenting and/or displaying text that identifies the type or class of object detected by AI model 418 as a chip stack. For example, circuitry 404 may overlay and/or superimpose a stack score 1116 proximate to bounding box 1114. In this example, stack score 1116 may identify the type or class of object detected by AI model 418 as a chip stack with a confidence of “0.98.”

Additionally or alternatively, implementation 1200 may involve presenting and/or displaying text that indicates different colors of the chips included in the chip stack detected by AI model 418. For example, circuitry 404 may generate, overlay, and/or superimpose color score 1030, color score 1032, color score 1034, color score 1036, color score 1038, color score 1040, and/or color score 1042 over and/or in line with the respective chips of the stack. In this example, color score 1030 may identify the color of the first chip as green with a confidence of “0.97,” color score 1032 may identify the color of the second chip as black with a confidence of “0.98,” color score 1034 may identify the color of the third chip as blue with a confidence of “0.96,” color score 1036 may identify the color of the fourth chip as red with a confidence of “0.97,” color score 1038 may identify the color of the fifth chip as green with a confidence of “0.98,” color score 1040 may identify the color of the sixth chip as white with a confidence of “0.97,” and/or color score 1042 may identify the color of the seventh chip as blue with a confidence of “0.99.”

FIG. 13 is a flow diagram of an exemplary computer-implemented method 1350 for detecting and/or accounting for features of wagering games. In one example, the steps shown in FIG. 13 may be achieved and/or accomplished by all or a portion of system 400 in FIG. 4. Additionally or alternatively, the steps shown in FIG. 13 may incorporate and/or involve certain sub-steps and/or variations consistent with the descriptions provided above in connection with FIGS. 1-12.

As illustrated in FIG. 13, method 1350 may include the step of identifying, by circuitry included in a computing system, one or more attributes of a set of wagering chips based at least in part on data that represents at least one image of the set of wagering chips (1352). Step 1352 may be performed in a variety of ways, including any of those described above in connection with FIGS. 1-12. For example, circuitry included in a computing system may identify one or more attributes of a set of wagering chips based at least in part on data that represents at least one image of the set of wagering chips.

Method 1350 may also include the step of estimating, by the circuitry, a total value of the set of wagering chips based at least in part on the attributes (1354). Step 1354 may be performed in a variety of ways, including any of those described above in connection with FIGS. 1-12. For example, the circuitry may estimate a total value of the set of wagering chips based at least in part on the attributes.

Method 1350 may further include the step of accounting, by the circuitry, for the total value of the set of wagering chips in a wagering game application (1356). Step 1356 may be performed in a variety of ways, including any of those described above in connection with FIGS. 1-12. For example, the circuitry may account for the total value of the set of wagering chips in a wagering game application.

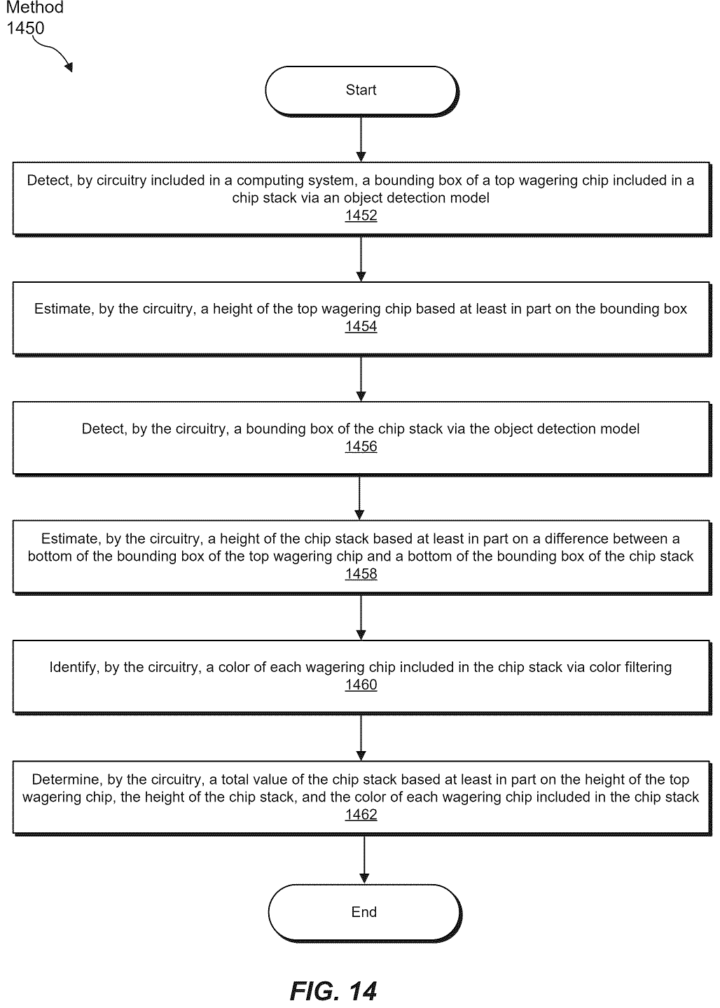

Various other methods may also facilitate and/or support detecting and/or accounting for features of wagering games. Some of these other methods may involve and/or implement computer vision and/or AI-driven functionalities. FIG. 14 is a flow diagram of an additional exemplary computer-implemented method 1450 for detecting and/or accounting for features of wagering games. In one example, the steps shown in FIG. 14 may be achieved and/or accomplished by all or a portion of system 400 in FIG. 4. Additionally or alternatively, the steps shown in FIG. 14 may incorporate and/or involve certain sub-steps and/or variations consistent with the descriptions provided above in connection with FIGS. 1-13.

As illustrated in FIG. 14, method 1450 may include the step of detecting, by circuitry included in a computing system, a bounding box of a top wagering chip included in a chip stack via an object detection model (1452). Step 1452 may be performed in a variety of ways, including any of those described above in connection with FIGS. 1-13. For example, circuitry included in a computing system may detect a bounding box of a top wagering chip included in a chip stack via an object detection model. In one example, the circuitry may apply the bounding box to the top wagering chip via the object detection model.

Method 1450 may also include the step of estimating, by the circuitry, a height of the top wagering chip based at least in part on the bounding box (1454). Step 1454 may be performed in a variety of ways, including any of those described above in connection with FIGS. 1-13. For example, the circuitry may estimate and/or determine the height of the top wagering chip based at least in part on the bounding box. In one example, the circuitry may perform this height estimation and/or determination based at least in part on one or more additional bounding boxes applied to and/or detected on other features of the chip stack (e.g., other chips included in the chip stack and/or the chip stack itself).

Method 1450 may further include the step of detecting, by the circuitry, a bounding box of the chip stack via the object detection model (1456). Step 1456 may be performed in a variety of ways, including any of those described above in connection with FIGS. 1-13. For example, the circuitry may detect a bounding box of the chip stack via the object detection model. In one example, the circuitry may apply the bounding box to the top wagering via the object detection model.

Method 1450 may additionally include the step of estimating, by the circuitry, a height of the chip stack based at least in part on a difference between a bottom of the bounding box of the top wagering chip and a bottom of the bounding box of the chip stack (1458). Step 1458 may be performed in a variety of ways, including any of those described above in connection with FIGS. 1-13. For example, the circuitry may estimate the height of the chip stack based at least in part on the difference between the bottom of the bounding box of the top wagering chip and the bottom of the bounding box of the chip stack.

Method 1450 may also include the step of identifying, by the circuitry, a color of each wagering chip included in the chip stack via color filtering (1460). Step 1460 may be performed in a variety of ways, including any of those described above in connection with FIGS. 1-13. For example, the circuitry may detect, determine, and/or identify the color of each wagering chip included in the chip stack via color filtering and/or instance segmentation.

Method 1450 may further include the step of determining, by the circuitry, a total value of the chip stack based at least in part on the height of the top wagering chip, the height of the chip stack, and/or the color of each of the wagering chip included in the chip stack (1462). Step 1462 may be performed in a variety of ways, including any of those described above in connection with FIGS. 1-13. For example, the circuitry may estimate, calculate, and/or determine the total value of the chip stack based at least in part on the height of the top wagering chip, the height of the chip stack, and/or the color of each of the wagering chip included in the chip stack. In one example, the circuitry may estimate, calculate, and/or determine the number of wagering chips included in the chip stack by dividing the height of the chip stack by the height of the top wagering chip. In this example, the circuitry may assign and/or apply values to each of the wagering chips included in the chip stack in accordance with their respective colors. The circuitry may then estimate, calculate, and/or determine the total value of the chip stack by summing up the values assigned and/or applied to each of the wagering chips included in the chip stack.

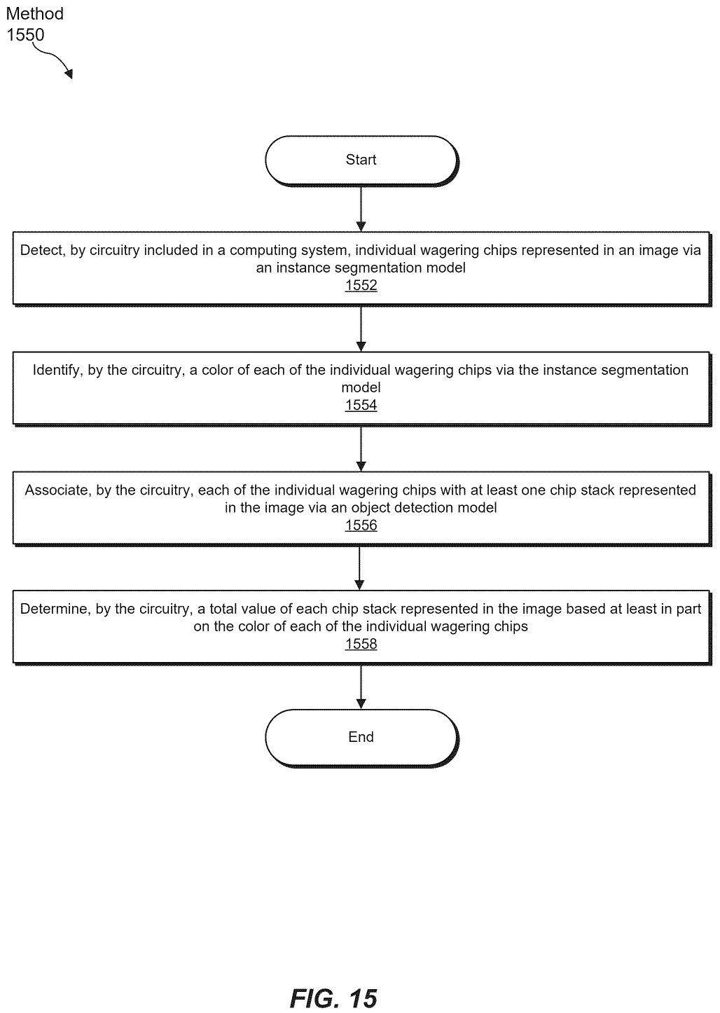

FIG. 15 is a flow diagram of an additional exemplary computer-implemented method 1550 for detecting and/or accounting for features of wagering games. In one example, the steps shown in FIG. 15 may be achieved and/or accomplished by all or a portion of system 400 in FIG. 4. Additionally or alternatively, the steps shown in FIG. 12 may incorporate and/or involve certain sub-steps and/or variations consistent with the descriptions provided above in connection with FIGS. 1-14.

As illustrated in FIG. 15, method 1550 may include the step of detecting, by circuitry included in a computing system, individual wagering chips represented in an image via an instance segmentation model (1552). Step 1552 may be performed in a variety of ways, including any of those described above in connection with FIGS. 1-14. For example, circuitry included in a computing system may detect and/or identify individual wagering chips represented in an image via an instance segmentation model.

Method 1550 may also include the step of identifying, by the circuitry, a color of each of the individual wagering chips via the instance segmentation model (1554). Step 1554 may be performed in a variety of ways, including any of those described above in connection with FIGS. 1-14. For example, the circuitry may detect, determine, and/or identify a color of each of the individual wagering chips via the instance segmentation model.

Method 1550 may further include the step of associating, by the circuitry, each of the individual wagering chips with at least one chip stack represented in the image via an object detection model (1556). Step 1556 may be performed in a variety of ways, including any of those described above in connection with FIGS. 1-14. For example, the circuitry may associate each of the individual wagering chips with at least one chip stack represented in the image via an object detection model. In one example, the circuitry may assign some of the individual wagering chips to one chip stack represented in the image via the object detection model and then assign other individual wagering chips to another chip stack represented in the image via the object detection model.

Method 1550 may additionally include the step of determining, by the circuitry, a total value of each chip stack represented in the image based at least in part on the color of each of the individual wagering chips (1558). Step 1558 may be performed in a variety of ways, including any of those described above in connection with FIGS. 1-14. For example, the circuitry may detect, determine, and/or identify a total value of each chip stack represented in the image based at least in part on the color of each of the individual wagering chips.

FIG. 16 illustrates an exemplary system 1600 for detecting and/or accounting for features of wagering games. As illustrated in FIG. 16, system 1600 may include and/or involve certain devices, components, configurations, and/or features that perform and/or provide functionalities that are similar and/or identical to those described above in connection with any of FIG. 1-15. In some examples, system 1600 may include and/or represent circuitry 404, storage device 406, display device 408, and/or camera device 410. In one example, system 1600 may be deployed and/or implemented in an environment (e.g., a casino, a security room, a recording studio, etc.) where at least a portion of a real-world table game (e.g., roulette) is played.

In some examples, circuitry 404 may be communicatively coupled to storage device 406, display device 408, and/or camera device 410 via direct and/or indirect connections. In one example, camera device 410 may take and/or capture one or more images 1660(1)-(N) of roulette wheel 1664 as video or stills. In this example, camera device 410 may transmit, send, and/or communicate images 1660(1)-(N) of roulette wheel 1664 to circuitry 404, storage device 406, and/or display device 408. In certain implementations, images 1660(1)-(N) may capture, show, and/or represent roulette wheel spins, turns, or rounds performed on roulette wheel 1664 in connection with a wagering game.

In some examples, storage device 406 may store, maintain, and/or save images 1660(1)-(N) as data 1652. In one example, circuitry 404 may identify one or more attributes 1654 of roulette wheel spins based at least in part on images 1660(1)-(N) represented in data 1652. For example, circuitry 404 may execute and/or implement AI model 418 to identify, detect, and/or determine attributes 1654 based at least in part on images 1660(1)-(N). Examples of attributes 1654 include, without limitation, a slot into which a roulette ball has landed, the center of roulette wheel 1664, the initial position of the slot that catches the roulette ball, a reference position associated with roulette wheel 1664, the angle between the initial position of the slot and the reference position, the distance between the center of roulette wheel 1664 and the slot, the distance between the roulette position and the initial position of the slot, the distance between the center of roulette wheel 1664 and the reference position, whether the roulette ball is moving around a ball track of roulette wheel 1664, combinations or variations of one or more of the same, portions of one or more of the same, and/or any other suitable attributes of roulette wheel spins.

In some examples, storage device 406 may store, maintain, and/or save a video 1666. In one example, circuitry 404 may convert, divide, and/or transform video 1666 into images 1660(1)-(N) and/or data 1652. Additionally or alternatively, circuitry 404 may store and/or maintain images 1660(1)-(N) as stills for use in detecting and/or predicting which slot catches the roulette ball during the roulette wheel spin.

In some examples, roulette wheel 1664 may include and/or represent a rotor that spins and/or rotates around its center. In one example, roulette wheel 1664 may also include and/or represent a set of slots arranged, set, and/or positioned around the rotor. In this example, each of the slots may be configured and/or fitted to accept and/or catch the roulette ball during and/or as a part of a roulette wheel spin. Additionally or alternatively, each of the slots may correspond to and/or be represented by a number relevant to the wagering game.

In some examples, roulette wheel 1664 may include and/or represent a ball track surrounding the rotor. In one example, the ball track may be configured and/or fitted to support the roulette ball as it moves and/or circles around the rotor. In this example, the roulette ball may move and/or transfer from the ball track toward the rotor and/or the slots as the roulette ball loses momentum, force, and/or speed during a roulette wheel spin. The roulette ball may eventually land and/or lodge in one of the slots arranged around or along the perimeter of the rotor.

In some examples, circuitry 404 may identify and/or determine attributes 1654 of a roulette wheel spin based at least in part on images 1660(1)-(N). In one example, circuitry 404 may identify, detect, forecast, anticipate, and/or predict which slot of roulette wheel 1664 catches the roulette ball during the roulette wheel spin based at least in part on attributes 1654. In this example, circuitry 404 may identify, detect, and/or classify a slot number 1656 as corresponding to the slot that caught the roulette ball during the roulette wheel spin. Additionally or alternatively, circuitry 404 may account for and/or apply slot number 1656 in wagering game application 416. For example, circuitry 404 may provide display device 408 with instructions and/or commands that, upon execution, cause display device 408 to present and/or display a graphical representation of wagering game application 416 and/or a graphical representation 1662 of slot number 1656.

In some examples, circuitry 404 may identify and/or determine attributes 1654 of the roulette wheel spin via AI model 418 based at least in part on data 1652. As a specific example, AI model 418 may include and/or represent a convolutional neural network that involves various layers, such as one or more convolution layers, activation layers, pooling layers, and fully connected layers. In this example, circuitry 404 may pass all or a portion of data 1652 through the convolutional neural network to identify, detect, forecast, anticipate, and/or predict which slot of roulette wheel 1664 catches the roulette ball during the roulette wheel spin based at least in part on attributes 1654. Additionally or alternatively, pass all or a portion of data 1652 through the convolutional neural network to identify, detect, classify, and/or determine slot number 1656 corresponding to the winning slot based at least in part on attributes 1654.

In the convolutional neural network, all or a portion of data 1652 may first encounter the convolution layer. At the convolution layer, all or a portion of data 1652 may be convolved using a filter and/or kernel. In particular, the convolution layer may cause circuitry 404 to slide a matrix function window over and/or across all or a portion of data 1652. Circuitry 404 may then record the resulting data convolved by the filter and/or kernel. In one example, one or more nodes included in the filter and/or kernel may be weighted by a certain magnitude and/or value.

After completion of the convolution layer, the convolved representation of all or a portion of data 1652 may encounter the activation layer. At the activation layer, the convolved data may be subjected to a non-linear activation function. In one example, the activation layer may cause circuitry 404 to apply the non-linear activation function to the convolved data. By doing so, circuitry 404 may be able to identify and/or learn certain non-linear patterns, correlations, and/or relationships between different regions of the convolved data.

In some examples, circuitry 404 may apply one or more of these layers included in the convolutional neural network to all or a portion of data 1652 multiple times. As such data completes all the layers, the convolutional neural network may render an estimation, detection, calculation, and/or classification of the slot that caught the roulette ball and/or the slot number based at least in part on data 1652. In one example, the estimation, detection, calculation, and/or classification may indicate and/or identify the slot that caught the roulette ball and/or the slot's number.

In some examples, AI model 418 may be trained and/or constructed with training data that includes various samples. Examples of such training data include, without limitation, images of roulette wheel spins captured at different angles over roulette wheels, images of roulette wheel spins in which roulette balls land in different slots, images of roulette wheel spins in which roulette balls caught in different slots are rotated to different positions around roulette wheels, images of slot numbers captured at different angles, images of slot numbers captured in environments of varied lighting, images of slot numbers captured with backgrounds of different colors, images of slot numbers shown in different color, images of slot numbers captured with different clarities or resolutions, combinations or variations of one or more of the same, portions of one or more of the same, and/or any other suitable training data.

In some examples, AI model 418 may be trained by circuitry 404. In other examples, AI model 418 may be trained by another computing device—whether inside or outside of system 1600. In one example, AI model 418 may be trained in the same environment (e.g., the same casino, the same security room, the same recording studio, etc.) as at least a portion of the real-world table game (e.g., roulette) is played. For example, AI model 418 may be trained on images captured from the same game table or a similar game table as the one used for the real-world table game. Additionally or alternatively, AI model 418 may be trained on images captured from various game tables—whether inside or outside of the environment where the real-world table game is played.

In some examples, the computer-vision technology executed and/or implemented by circuitry 404 may involve various functions. For example, the computer-vision technology may involve and/or perform image classification in which the types or classes of objects represented and/or captured in images 1660(1)-(N) is predicted. In another example, the computer-vision technology may involve and/or perform object localization in which the locations of such objects are identified and/or indicated in images 1660(1)-(N). In a further example, the computer-vision technology may involve and/or perform object detection in which a bounding box is applied to and/or overlaid atop one or more of such objects and/or in which certain objects are differentiated from one another by type or class. Additionally or alternatively, the computer-vision technology may involve and/or perform instance segmentation in which the distinct objects are segmented and/or delineated from one another.

In some examples, the various devices, components, and/or features described in connection with FIG. 4 or FIG. 16 may include and/or represent one or more additional circuits, components, and/or features that are not necessarily illustrated and/or labeled in FIG. 4 or FIG. 16. For example, the systems, components, and/or features illustrated in FIGS. 4 and 16 may also include and/or represent additional analog and/or digital circuitry, onboard logic, transistors, transmitters, receivers, transceivers, cabling, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, combinations or variations of one or more of the same, and/or any other suitable components. In certain implementations, one or more of these additional circuits, components, and/or features may be inserted and/or applied between any of the existing circuits, components, and/or features illustrated in FIG. 4 or FIG. 16 consistent with the aims and/or objectives described herein. Accordingly, the couplings and/or connections described with reference to FIG. 4 or FIG. 16 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components.

In some examples, one or more of the various devices, components, and/or features described in connection with FIG. 4 or FIG. 16 may be excluded and/or omitted from system 400 or system 1600. For example, rather than including and/or incorporating camera device 410, alternative embodiments of system 400 or system 1600 may enable circuitry 404 and/or storage device 406 to obtain data 432, data 1652, images 430(1)-(N), and/or images 1660(1)-(N) from an external camera device. In another example, rather than including and/or incorporating display device 408, alternative embodiments of system 400 or system 1600 may enable circuitry 404 to provide an external display device with instructions and/or commands that, upon execution, cause the external display device to present and/or display a graphical representation of wagering game application 416, graphical representation 422 of total value 414, and/or graphical representation 1662 of slot number 1656.

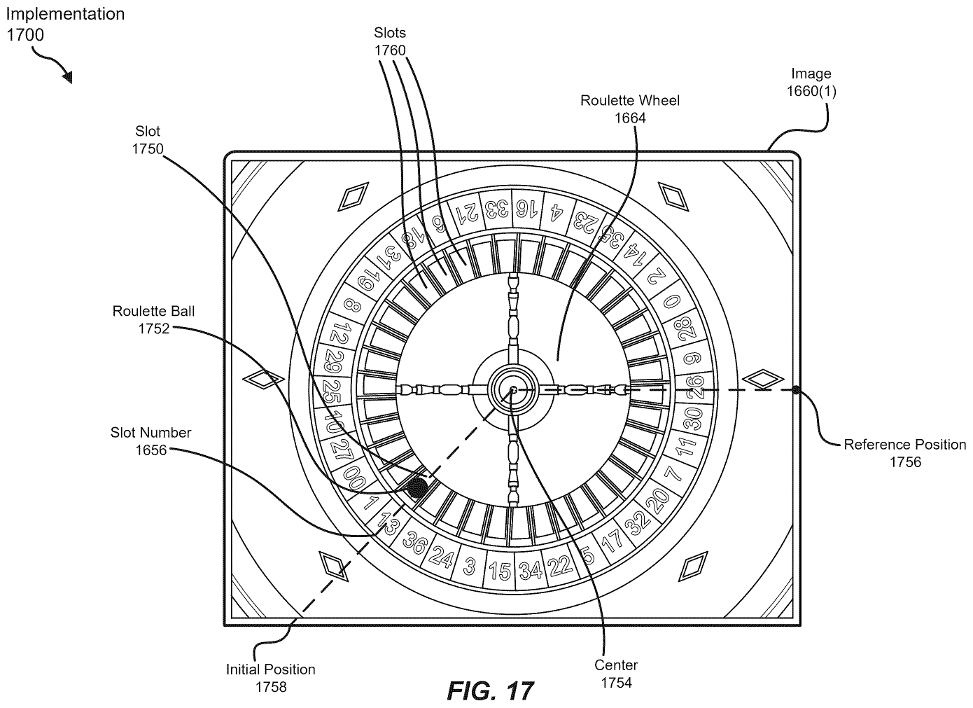

FIG. 17 illustrates an exemplary implementation 1700 of a roulette wheel spin captured and/or represented in image 1660(1). In some examples, implementation 1700 may include and/or represent certain elements, components, and/or features that perform and/or provide functionalities that are similar and/or identical to those described above in connection with FIGS. 1-16. As illustrated by image 1660(1) in FIG. 17, the roulette wheel spin may involve and/or represent a roulette ball 1752 that lands in a slot 1750 of roulette wheel 1664. In one example, slot number 1656 may correspond to and/or represent slot 1750 in which roulette ball 1752 lands during the roulette wheel spin. In this example, roulette ball 1752 may escape and/or avoid landing in slots 1760 of roulette wheel 1664 during the roulette wheel spin.

In some examples, image 1660(1) may show and/or represent a moment in time when slot 1750 and/or roulette ball 1752 are located at an initial position 1758 relative to a center 1754 of roulette wheel 1664 and/or a reference position 1756 associated with roulette wheel 1664. Reference position 1756 may constitute and/or represent any orientation of image 1660(1) that is used to normalize and/or standardize the process of classifying and/or identifying the number corresponding to the winning slot. In one example, circuitry 404 may identify, detect, and/or determine that roulette ball 1752 has landed in slot 1750 of roulette wheel 1664 in image 1660(1). In this example, circuitry 404 may identify, detect, and/or determine initial position 1758 of slot 1750 and/or roulette ball 1752 in image 1660(1). In certain implementations, circuitry 404 may identify, detect, and/or determine an angle between initial position 1758 of slot 1750 and/or roulette ball 1752 and reference position 1756 relative to center 1754 in image 1660(1).

In some examples, circuitry 404 may execute and/or implement AI model 418 to identify, detect, and/or determine that slot 1750 caught roulette ball 1752. For example, AI model 418 may include and/or represent an object detection model that enables circuitry 404 to detect and/or identify slot 1750 as having caught roulette ball 1752 as part of the roulette wheel spin based at least in part on the attributes of image 1660(1). Additionally or alternatively, circuitry 404 may execute and/or implement AI model 418 to identify, detect, and/or determine initial position 1758 and/or the angle between initial position 1758 and reference position 1756. For example, the object detection model of AI model 418 may enable circuitry 404 to identify, detect, and/or determine initial position 1758 and/or the angle between initial position 1758 and reference position 1756 based at least in part on the attributes of image 1660(1).

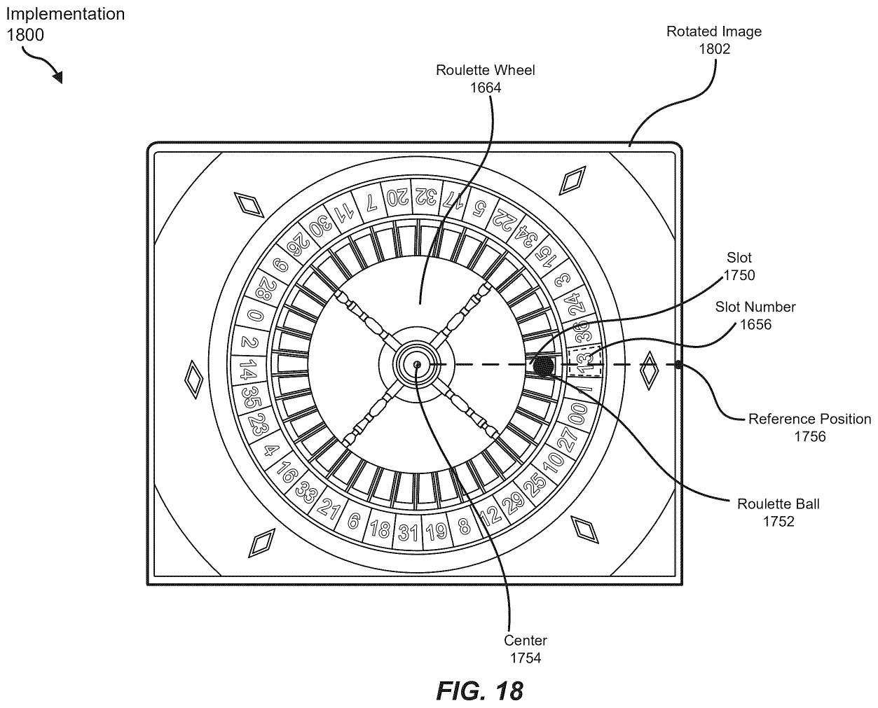

FIG. 18 illustrates an exemplary implementation 1800 of a roulette wheel spin captured and/or represented in a rotated image 1802. In some examples, implementation 1800 may include and/or represent certain elements, components, and/or features that perform and/or provide functionalities that are similar and/or identical to those described above in connection with FIGS. 1-17. As illustrated by rotated image 1802 in FIG. 18, the roulette wheel spin may involve and/or represent roulette ball 1752 that landed in slot 1750 of roulette wheel 1664. In one example, rotated image 1802 may show and/or represent the same roulette wheel spin captured and/or portrayed in image 1660(1) in FIG. 17. However, image 1660(1) may have been rotated and/or altered to align slot 1750 and/or roulette ball 1752 with reference position 1756.

In some examples, the rotation of this image may provide and/or serve one or more technical benefits and/or advantages. For example, by rotating the image in this way, circuitry 404 may effectively standardize and/or normalize the orientation of the slot number for quicker and/or more accurate detection and/or identification. Additionally or alternatively, by rotating the image in this way, circuitry 404 may enable the AI model to perform the detection and/or identification of the slot number with less AI training. In other words, circuitry 404 may implement and/or rely on a less complicated AI model to accurately detect and/or identify the slot number. For example, this AI model may be built and/or trained with less and/or fewer training data than is otherwise necessary to ensure accurate detection and/or identification without such image rotation and/or alignment.

In some examples, circuitry 404 may rotate and/or turn some or all of image 1660(1) in FIG. 17 such that slot 1750 and/or roulette ball 1752 align with reference position 1756. This rotation and/or turn of image 1660(1) in FIG. 17 may render, form, and/or result in rotated image 1802 in FIG. 18. For example, circuitry 404 may rotate and/or turn image 1660(1) by an amount and/or degree equivalent to the angle between initial position 1758 and reference position 1756 in image 1660(1). In one example, circuitry 404 may calculate and/or determine the angle between initial position 1758 and reference position 1756 in image 1660(1) by applying a trigonometric function that involves and/or accounts for the center of roulette wheel 1664, initial position 1758, and/or reference position 1756.

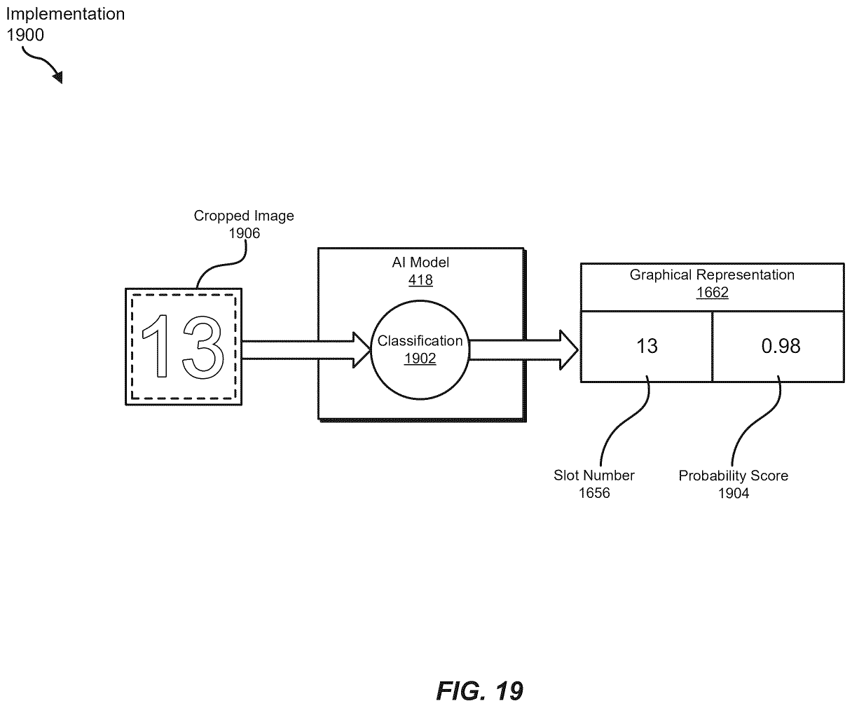

FIG. 19 illustrates an exemplary implementation 1900 of a classification 1902 performed by AI model 418 on a cropped image 1906 of slot number 1656. In some examples, implementation 1900 may include and/or represent certain elements, components, and/or features that perform and/or provide functionalities that are similar and/or identical to those described above in connection with FIGS. 1-18. In one example, circuitry 404 may crop a portion of rotated image 1802 to isolate, separate, and/or focus on the graphical representation of slot number 1656. As a result, circuitry 404 may generate, create, and/or render cropped image 1906 of slot number 1656. In this example, circuitry 404 may identify, detect, classify, and/or determine slot number 1656 corresponding to the winning slot based at least in part on cropped image 1906.

In some examples, circuitry 404 may execute and/or implement AI model 418 to identify, detect, classify, and/or determine slot number 1656. For example, AI model 418 may include and/or represent a classification model that enables circuitry 404 to identify, detect, classify, and/or determine slot number 1656 based at least in part on the attributes of cropped image 1906. In other words, circuitry 404 may pass cropped image 1906 through the classification model to identify, detect, classify, and/or determine slot number 1656 corresponding to the winning slot. By doing so, circuitry 404 may rely on the classification model to perform a classification 1902 of the number represented in cropped image 1906. In this example, classification 1902 may indicate and/or identify the number represented in cropped image 1906 as the number “13,” meaning that roulette ball 1752 landed in the slot labeled “13” on roulette wheel 1664 during the roulette wheel spin.

In some examples, circuitry 404 may cause and/or direct display device 408 to present and/or display graphical representation 1662 of slot number 1656 in connection with wagering game application 416. Additionally or alternatively, circuitry 404 may generate a probability score 1904 that represents the probability that slot number 1656 has been identified correctly via in classification 1902. In one example, circuitry 404 may cause and/or direct display device 408 to present and/or display probability score 1904 in graphical representation 1662 in connection with wagering game application 416. For example, as presented and/or displayed by display device 408, graphical representation 1662 may identify and/or indicate that the winning slot is number “13” and the corresponding probability score is “0.98.”

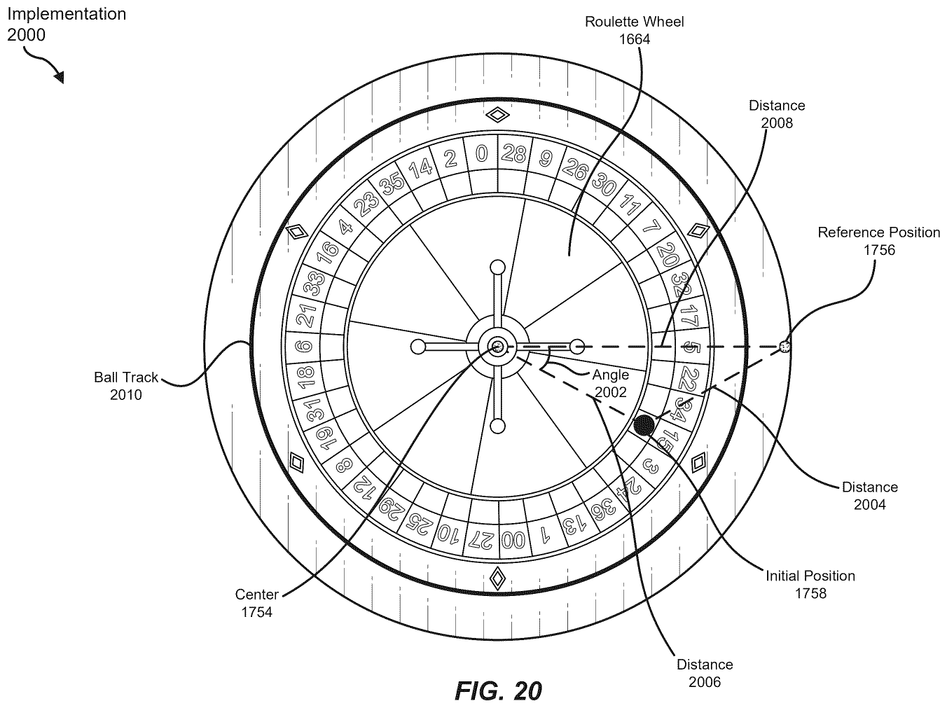

FIG. 20 illustrates an exemplary implementation 2000 of a roulette wheel spin captured and/or represented in at least one of images 1660(1)-(N). In some examples, implementation 2000 may include and/or represent certain elements, components, and/or features that perform and/or provide functionalities that are similar and/or identical to those described above in connection with FIGS. 1-19. As illustrated in FIG. 20, the roulette wheel spin may involve and/or represent roulette ball 1752 having landed in the number “15” slot of roulette wheel 1664.

In some examples, circuitry 404 may identify, detect, and/or determine that roulette ball 1752 has landed in the number “15” slot in implementation 2000. Additionally or alternatively, circuitry 404 may identify, detect, and/or determine that the number “15” slot is shown and/or represented at an initial position 1758 relative to center 1754 and/or reference position 1756. In one example, circuitry 404 may identify, detect, and/or determine an angle 2002 between initial position 1758 of the number “15” slot and reference position 1756 relative to center 1754.

In some examples, circuitry 404 may calculate and/or determine angle 2002 by applying at least one trigonometric function that involves center 1754, initial position 1758, and/or reference position 1756. In one example, the trigonometric function may include and/or represent an inverse cosine function that involves squared values of a distance 2004 between reference position 1756 and initial position 1758, a distance 2006 between center 1754 and the winning slot (e.g., initial position 1758), and/or a distance 2008 between center 1754 and reference position 1756. For example, circuitry 404 may calculate and/or determine angle 2002 by applying the following formula:

$$A = {cos}^{- 1} ( \frac{{b}^{2} + {c}^{2} + {a}^{2}}{2 bc} ) = angle 2002 = {cos}^{- 1} ( \frac{{( distance 1706 )}^{2} + {( distance 1708 )}^{2} + {( distance 1704 )}^{2}}{2 ( distance 1706 \times distance 1708 )} ) .$$

Accordingly, circuitry 404 may calculate and/or determine calculate angle 2002 by multiplying distance 2006 by distance 2008, doubling the product of the multiplication, dividing the sum of the squared values of distances 2006, 2008, and 2004 by the doubled product, and then applying the quotient of the division to the inverse cosine function.

In some examples, circuitry 404 may rotate and/or turn the image of the roulette wheel spin by an amount and/or degree equivalent to angle 2002 to align the number “15” slot with reference position 1756. In one example, upon so rotating and/or turning the image, circuitry 404 may crop, separate, and/or isolate the winning slot for number classification and/or identification.

In some examples, circuitry 404 may curate and/or winnow images 1660 (1)-(N) to exclude any or all that show and/or depict roulette ball 1752 moving and/or circling around a ball track 2010 that surrounds roulette wheel 1664. In such examples, circuitry 404 may ensure that any or all excluded images are disregarded for the purpose of detecting and/or identifying winning roulette numbers. For example, circuitry 404 may prevent any or all excluded images from being used to identify attributes 1654 from which the winning roulette number is detected and/or determined.

FIG. 21 is a flow diagram of an exemplary computer-implemented method 2100 for detecting and/or accounting for features of wagering games. In one example, the steps shown in FIG. 21 may be achieved and/or accomplished by all or a portion of system 1600 in FIG. 16. Additionally or alternatively, the steps shown in FIG. 21 may incorporate and/or involve certain sub-steps and/or variations consistent with any of the descriptions provided above in connection with FIGS. 1-20.

As illustrated in FIG. 21, method 2100 may include the step of identifying, by circuitry included in a computing system, one or more attributes of a roulette wheel spin based at least in part on data that represents at least one image of the roulette wheel spin (2102). Step 2102 may be performed in a variety of ways, including any of those described above in connection with FIGS. 1-20. For example, circuitry included in a computing system may identify one or more attributes of a roulette wheel spin based at least in part on data that represents at least one image of the roulette wheel spin.

Method 2100 may also include the step of predict, by the circuitry, which slot of a roulette wheel catches a roulette ball during the roulette wheel spin based at least in part on the attributes (2104). Step 2104 may be performed in a variety of ways, including any of those described above in connection with FIGS. 1-20. For example, the circuitry may predict which slot of a roulette wheel catches a roulette ball during the roulette wheel spin based at least in part on the attributes.

Method 2100 may further include the step of accounting for a number corresponding to the slot of the roulette wheel in a wagering game application (2106). Step 2106 may be performed in a variety of ways, including any of those described above in connection with FIGS. 1-20. For example, the circuitry may account for a number corresponding to the slot of the roulette wheel in a wagering game application.

In some examples, the various embodiments and/or implementations described herein may also be extended and/or applied to other wagering games, including those involving dice and/or playing cards. In one example, a computer-vision system may be implemented in connection with craps games to facilitate detecting and/or identifying the numbers and/or combinations rolled with dice. For example, circuitry 404 may implement and/or apply the object detection model of AI model 418 to detect and/or identify one or more upward faces of one or more dice. Additionally or alternatively, circuitry 404 may implement and/or apply the classification model of AI model 418 to classify, characterize, and/or identify the number represented on such upward faces of the dice. In certain implementations, the classification model may generate and/or provide a score that represents the probability that such numbers have been identified correctly and/or successfully.

As another example, a computer-vision system may be implemented in connection with poker and/or blackjack to facilitate detecting and/or identifying the cards played on a corresponding table and/or held or included in a player's hand. For example, circuitry 404 may implement and/or apply the object detection model of AI model 418 to detect and/or identify the sides of one or more cards that each show a suit and/or rank. Additionally or alternatively, circuitry 404 may implement and/or apply the classification model of AI model 418 to classify, characterize, and/or identify the suit and/or rank represented on such sides of the cards. In certain implementations, the classification model may generate and/or provide a score that represents the probability that the suit and/or rank have been identified correctly and/or successfully.

[Inventor(s): The Following Section is Boilerplate and does not Require Your Review]

In some examples, one or more of the embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-executable and/or computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into circuitry 404 and/or storage device 406. When executed by circuitry 404, a computer program loaded into storage device 406 causes circuitry 404 to perform and/or be a means for performing the functions of one or more of the example embodiments described and/or illustrated herein. Additionally or alternatively, one or more of the example embodiments described and/or illustrated herein are implemented in firmware and/or hardware. For example, circuitry 404 is configured as an ASIC adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

### [END OF BOILERPLATE]

What is claimed is:

1. A system comprising:
at least one storage device configured to store data that represents at least one image of a set of wagering chips; and
circuitry configured to:
detect, via an object detection model of an artificial intelligence (AI) model, a bounding box of at least one of the wagering chips included in the set based at least in part on the image represented in the data;
identify an attribute of the at least one of the wagering chips based at least in part on the bounding box;
estimate a total value of the set of wagering chips based at least in part on the attribute of the at least one of the wagering chips; and
account for the total value of the set of wagering chips in a wagering game application.

2. The system of claim 1, wherein the AI model is trained by training data comprising at least one of:
images of an individual wagering chip captured at different angles;
images of an individual wagering chip captured at different rotations;
images of stacks of wagering chips with different combinations of colors; or
images of stacks of wagering chips with different orders of color combinations.

3. The system of claim 1, wherein the set of wagering chips are configured in a stack.

4. The system of claim 3, wherein the circuitry is further configured to:
detect, via the object detection model, an additional bounding box of the stack based at least in part on the image represented in the data;
identify an attribute of the stack based at least in part on the additional bounding box; and
estimate the total value of the stack based at least in part on the attribute of the stack and the attribute of the at least one of the wagering chips.

5. The system of claim 3, wherein the circuitry is further configured to:
measure at least one dimension of the stack based at least in part on the image represented in the data; and
estimate the total value of the stack based at least in part on the dimension of the stack.

6. The system of claim 5, wherein the circuitry is further configured to:
apply the bounding box to a top wagering chip included in the stack;
apply an additional bounding box to the stack; and
measure the dimension of the stack by estimating a difference between a bottom of the top wagering chip and a bottom of the stack based at least in part on the bounding box and the additional bounding box.

7. The system of claim 6, wherein the circuitry is further configured to:
estimate a height measurement of the top wagering chip as captured in the image by:
identifying a set of coordinates corresponding to the top wagering chip as captured in the image;
normalizing a diameter measurement of the top wagering chip based at least in part on the set of coordinates;
multiplying the diameter measurement by a known height of the top wagering chip; and
dividing a product of the diameter measurement and the known height by a known diameter of the top wagering chip; and
estimate a height measurement of the stack based at least in part on the height measurement of the top wagering chip.

8. The system of claim 7, wherein the circuitry is further configured to adjust the height measurement of the top wagering chip to account for a projection of the height measurement of the top wagering chip on an image plane of the image by:
identifying an additional set of coordinates corresponding to the top wagering chip as captured in the image;
normalizing an angle measurement of the top wagering chip based at least in part on the additional set of coordinates; and
multiplying the height measurement of the top wagering chip by a sine function involving the angle measurement.

9. The system of claim 8, wherein the sine function comprises a sine function of a difference between:
a half of pi; and
an inverse sine function of the angle measurement divided by the diameter measurement.

10. The system of claim 8, wherein the circuitry is further configured to count a total number of wagering chips included in the set based at least in part on the adjusted height measurement.

11. The system of claim 1, wherein the circuitry is further configured to:
identify, via an instance segmentation model of the AI model, at least one wagering chip included in the set as being of a first color;
identify, via the instance segmentation model, at least one additional wagering chip included in the set as being of a second color; and
estimate the total value of the set by:
applying a first value to the wagering chip due at least in part to the wagering chip being of the first color; and
applying a second value to the additional wagering chip due at least in part to the additional wagering chip being of the second color.

12. The system of claim 11, wherein the circuitry is further configured to:
associate, via the object detection model, each of the wagering chips included in the set with at least one stack captured in the image; and
estimate the total value of the at least one stack based at least in part on the first value applied to the wagering chip and the second value applied to the additional wagering chip.

13. The system of claim 11, wherein the circuitry is further configured to:
identify the wagering chip as being of the first color by filtering the set for the first color; and
identify the additional wagering chip as being of the second color by filtering the set for the second color.

14. The system of claim 11, wherein the circuitry is further configured to:
identify the wagering chip as being of the first color based at least in part on a combination of a hue of the wagering chip, a light intensity of the wagering chip, and a color saturation of the wagering chip; and
identify the additional wagering chip as being of the second color based at least in part on a combination of a hue of the additional wagering chip, a light intensity of the additional wagering chip, and a color saturation of the additional wagering chip.

15. The system of claim 1, wherein the circuitry is further configured to:
identify the set of wagering chips as being in an unstacked configuration based at least in part on the image;
segment the set of wagering chips into individual graphical representations; and
create a virtual stack of the wagering chips by pasting the individual graphical representations atop of one another in a stacked configuration.

16. The system of claim 15, wherein the circuitry is further configured to incorporate the virtual stack in the wagering game application.

17. The system of claim 15, wherein the circuitry is further configured to count a total number of wagering chips included in the set based at least in part on the virtual stack.

18. The system of claim 15, wherein the circuitry is further configured to standardize one or more dimensions of the wagering chips included in the virtual stack against a virtual canvas.

19. A non-transitory computer-readable medium comprising one or more computer-executable instructions that, when executed by at least one hardware processor of a computing device, cause the hardware processor to:
detect, via an object detection model of an artificial intelligence (AI) model, a bounding box of at least one wagering chip based at least in part on data that represents at least one image of a set of wagering chips;
identify an attribute of the at least one wagering chip based at least in part on the bounding box;
estimate a total value of the set of wagering chips based at least in part on the attribute of the at least one wagering chip; and
account for the total value of the set of wagering chips in a wagering game application.

20. A computer-implemented method comprising:
detecting, by circuitry implementing an object detection model of an artificial intelligence (AI) model, a bounding box of at least one wagering chip based at least in part on data that represents at least one image of a set of wagering chips;
identifying, by the circuitry, an attribute of the at least one wagering chip based at least in part on the bounding box;
estimating, by the circuitry, a total value of the set of wagering chips based at least in part on the attribute of the at least one wagering chip; and
accounting for the total value of the set of wagering chips in a wagering game application.
